(19) United States
(12) Patent Application Publication
(10) Pub. No.: US 2025/0052635 A1
(43) Pub. Date: Feb. 13, 2025

(54) MOBILE ROBOTIC APPARATUS AND METHOD FOR USE IN BALANCING A VEHICLE WHEEL

(71) Applicant: HONGBIN WEN, Mississauga (CA)

(72) Inventor: HONGBIN WEN, Mississauga (CA)

(21) Appl. No.: 18/679,444

(22) Filed: May 30, 2024

(51) Int. Cl. G01M 1/02; G01M 1/16

(52) U.S. Cl. CPC G01M 1/02; G01M 1/16

(57) ABSTRACT

A mobile robot tool for use in testing balance of a wheel has a pressure plate assembly having a pressure plate member rotatable about the first attachment element. The pressure plate member is driven along a tool operational axis in one direction to cause the pressure plate member to bear against the wheel rim flat. A cone assembly has a cone block rotatable about the second attachment element. The cone block is driven along the axis in the opposite direction to drive it against the rim center bore on the other side of the wheel. The first and the second attachment elements are screwed together to clamp the rim between the core block and the pressure plate ready for conducting a wheel balance test.

### CROSS REFERENCE TO RELATED PATENTS

The present application is a continuation-in-part of pending U.S. patent application Ser. No. 17/943,444 filed Sep. 13, 2022, and entitled “Apparatus and methods for robotically servicing a vehicle wheel.”

U.S. patent application Ser. No. 17/943,444 is a continuation of U.S. patent application Ser. No. 16/403,477 filed May 3, 2019, now issued as U.S. Pat. No. 11,472,239, and entitled “Apparatus and methods for robotically servicing a vehicle wheel”.

U.S. patent application Ser. No. 16/403,477 is a continuation in part of U.S. patent application Ser. No. 16/104,792 filed Aug. 17, 2018, now issued as U.S. Pat. No. 10,926,365, and entitled “Apparatus and method for attaching and detaching circular arrayed fasteners”.

U.S. patent application Ser. No. 16/104,792 claims priority pursuant to 35 U.S.C. § 119 (e) from U.S. Provisional Patent Application Ser. No. 62/666,481 filed May 3, 2018, and entitled “Wheel loader” and from U.S. Provisional Patent Application Ser. No. 62/670,596 filed May 11, 2018,and entitled “Additional functions of wheel loader”.

The disclosures of the above-numbered applications are hereby incorporated herein by reference in their entirety and made part of the present application for all purposes.

### FIELD OF THE INVENTION

This invention relates to a robot tool for use in remotely and automatically balancing a vehicle wheel and to a method of using such a tool.

### BACKGROUND

There are many possible actions that can be undertaken in order to fully service a wheel, whether it is new, mounted on a vehicle or has been removed from a vehicle for off-vehicle servicing. Such servicing may for example involve any of identifying the wheel to be worked on, jacking up the part of the vehicle to which the wheel is attached, releasing and removing lug nuts or other fasteners from studs on the vehicle wheel hub, storing the fasteners in readiness for later wheel re-attachment or replacement, gripping and removing the wheel, examining the wheel for damage, tread life or balance, testing and regulating tire pressure, rebalancing the wheel, etc. There may be many different types, makes and models of vehicle with a corresponding variety of vehicle and wheel widths, diameters, and configurations. Currently, most wheel servicing actions are performed manually by a mechanic at a garage service bay, roadside or elsewhere. It is expensive and often inconvenient to have wheel servicing that is as manually intensive as current servicing practices.

### SUMMARY OF THE INVENTION

According to an aspect of the invention, there is provided a mobile robot tool for use in testing balance of a wheel, the wheel having a rim, a center bore through the rim, and a rim flat surrounding the bore at one end thereof, the tool comprising a tool base, a first assembly comprising a first pressure member mounted for rotation about a part of a first attachment clement, and a first drive operable to drive the first pressure member along a tool operational axis in a first direction to cause the first pressure member to contact and bear against the rim one side thereof, a second assembly comprising a second pressure member mounted for rotation about a second attachment element, and a second drive operable to drive the second pressure member in a second direction opposite to the first direction to cause second pressure member to contact and bear against the rim on the other side thereof, therefore the wheel rim is clamped between both pressure members. In a further embodiment, the tool comprising a third drive to drive a fastening engagement between the attachment elements to clamp the wheel rim between the attachment elements in a wheel balance test position.

Preferably, at least one of the first assembly and the second assembly is mounted to the tool base by an articulated mounting permitting the respective assembly to be driven between a first position in which the rotary axis of the respective pressure member is not aligned with the tool operational axis, and a second position in which the rotary axis of the respective pressure member thereof is aligned with the tool operational axis.

Preferably, the articulated mounting extends between the first assembly and the tool base, and the first drive is further operable to articulate the mounting to move the first assembly between a first position on one side of the wheel and a second position on the other side of the wheel when the wheel is in a wheel pre-test position.

Preferably, the first drive, in moving the first assembly between the first position and the second position, moves the first assembly around the wheel.

Preferably, the first attachment element is a threaded shaft coaxial with the cylindrical head of a pressure plate member which bearingly rotates, and the second attachment element is an end part of a shaft mounted to the tool base and axially aligned with the tool operational axis, the shaft end part having a threaded bore extending axially thereinto.

Preferably, the first assembly further comprises a driver to provide the first drive, the driver engageable with the first attachment element to screw drive the first attachment element.

Preferably, the first assembly further comprises a holding member connected to the pressure plate member, wherein the holding member is disconnectable from the pressure plate member when the wheel is in the test position, thereby leaving the wheel free to rotate about a central axis thereof.

Preferably, the robot tool further comprises a roller mounted to the tool base, a fourth drive to drive the roller from a standby position to a position in which an outer surface of the roller bears against an outer treaded surface of the wheel when in the test position, and a fifth drive to rotate the roller about a central axis thereof, whereby to counter-rotate the wheel.

Preferably, the robot tool further comprises a vibration monitoring sub-system mounted on the tool base for monitoring at least 2 of x, y and z vibrations of the wheel when the wheel is counter-rotating in the test position, and for relating the vibrations to respective positions on the wheel.

Preferably, the robot tool further comprises at least three grippers mounted to the tool base, wherein the wheel grippers are deployable to grip an outer tread surface of a wheel and to maneuver the wheel from a vehicle mount position to the pre-test position.

Preferably, at least one of the grippers incorporates a roller moveable to a position bearing against an outer treaded surface of the wheel in the test position, and a drive to rotate the roller, thereby to counter-rotate the wheel.

Preferably, the tool base is mounted on a chassis having a roller set for supporting the chassis on a supporting surface, the mobile robot tool further comprising a drive to the roller set operable to effect any of rectilinear, curvilinear and spin motion of the chassis on the supporting surface.

Preferably, the tool base is mounted on a chassis for movement on a supporting surface, the mobile robot further comprising a drive to effect tilt of the tool base relative to the chassis from a level position to a tilted position.

Preferably, the tool base is mounted on a chassis for movement on a supporting surface, the mobile robot further comprising a drive to effect a change of height of the tool base relative to the supporting surface.

Alternatively, the tool base is mounted on a robot arm as the EOAT (End Of Arm Tool), the robot arm can move the robot tool to a desired position in desired orientation in 3D space. In this case, the robot arm is used as chassis to alter the height and orientation of the tool base.

Preferably, the robot tool further comprises a tire inspection sub-system mounted on the tool base, wherein the tire inspection sub-system operable to inspect the wheel.

Preferably, the robot tool further comprises a foreign body removal sub-system operable to remove foreign bodies detected by said tire inspection sub-system to be lodged in a tread surface of the wheel.

Preferably, the robot tool further comprises an old weight removal sub-system mounted to the tool base, the old weight removal sub-system deployable to remove old weights from the wheel rim when the wheel is in the test position and prior to performance of a balance test of the wheel.

Preferably, the robot tool further comprises a new weight application sub-system mounted to the tool base, the new weight application sub-system deployable to apply new weights to the wheel rim when the wheel is in the test position and following performance of a balance test of the wheel.

Preferably, the robot tool further comprises a wheel rim-cleaning sub-system mounted to the tool base, wherein the wheel rim-cleaning sub-system is deployable to clean a new weight site prior to application of a new weight at the site.

According to an aspect of the invention, there is provided a method for use in testing balance of a wheel, the wheel having a rim, a center bore through the rim, and a rim flat surrounding the bore at one end thereof, the method comprising driving a first assembly comprising a pressure plate member forming part of a mobile robotic tool and mounted for rotation about a part of a first attachment element and moving along a tool operational axis in a first direction to cause the pressure plate member to bear against the rim flat at one end of the rim center bore, driving a second assembly comprising a second pressure member forming part of the mobile robotic tool and mounted for rotation about a second attachment element in a second direction opposite to the first direction to cause the 2nd pressure member thereof to bear against the other end of the rim center bore, at least one of the first assembly and the second assembly comprising a cone block with it's conical surface bearing against an edge of the rim center bore in a wheel balance testing and correction status, wherein the second attachment element has a second screw portion having a second screw axis, and screw engaging a first screw portion forming part of the first attachment element and having a first screw axis with a second screw portion forming part of the second attachment element and having a second screw axis, and driving the engagement between the first and second screw portions to clamp the wheel rim between the attachment elements in a wheel balance test position.

### BRIEF DESCRIPTION OF THE DRAWINGS

For simplicity and clarity of illustration, elements illustrated in the accompanying figure are not drawn to common scale. For example, the dimensions of some of the elements are exaggerated relative to other elements for clarity. Advantages, features, and characteristics of the present invention, as well as methods, operation, and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a perspective view from the front of a robot wheel servicing tool according to an embodiment of the invention.

FIG. 2 is a perspective view from the rear of the robot tool of FIG. 1.

FIG. 3 is a view from one side of the robot tool of FIG. 1.

FIG. 4 is an exploded perspective view of the robot tool of FIG. 1.

FIG. 5 is a top perspective view from the front and the other side of a chassis sub-system of the robot tool of FIG. 1 according to an embodiment of the invention.

FIG. 6 is a bottom perspective view from the back and the other side of the chassis sub-system of FIG. 5.

FIG. 7 is a top perspective view from the back and the other side of a tool support arrangement of the robot tool of FIG. 1 according to an embodiment of the invention.

FIG. 8 is an exploded view of the robot support arrangement of FIG. 7.

FIG. 9 is a side view of the tool support arrangement of FIG. 7 in one articulation.

FIG. 10 is a side view of the tool support arrangement of FIG. 7 in a second articulation.

FIG. 11 is a side view of the tool support arrangement of FIG. 7 in a third articulation.

FIG. 12 is a side view of the tool support arrangement of FIG. 7 in a fourth articulation.

FIG. 13 is a bottom perspective view from the front and one side of the robot tool of FIG. 1 showing a jacking sub-system of the robot tool according to an embodiment of the invention.

FIG. 14 is a top perspective view from the top and one side of the jacking sub-system illustrated in FIG. 13.

FIG. 15 is a bottom view of the jacking sub-system illustrated in FIG. 13.

FIG. 16 is a scrap perspective view of the jacking sub-system of FIG. 13 showing one stage in deployment thereof.

FIG. 17 is a scrap perspective view corresponding to the view of FIG. 16 but showing a subsequent stage in deployment thereof.

FIG. 18 is a scrap perspective view corresponding to the view of FIG. 17 but showing a later stage in deployment thereof.

FIG. 19 is a top perspective view from the front and one side of a part of the robot tool of FIG. 1 showing a gripper sub-system according to an embodiment of the invention.

FIG. 20 is a top perspective view from the back and one side showing the gripper sub-system of FIG. 19 at a stage in deployment thereof.

FIG. 21 is a side perspective view from the back and one side showing the gripper sub-system of FIG. 20 at a later stage in deployment thereof.

FIG. 22 is a perspective view from the front and one side of a wheel showing use of a first set of sensors for positioning the gripper sub-system of FIG. 19 on a wheel.

FIG. 23 is a side view of a wheel showing use of a second set of sensors for positioning the gripper sub-system of FIG. 19 on a wheel.

FIG. 23A is a scrap perspective view showing one embodiment of gripper for use in the gripper sub-system of FIG. 19.

FIG. 24 is a top perspective view from the back and one side of a part of the robot tool of FIG. 1 showing a fastener storage sub-system according to an embodiment of the invention.

FIG. 25 is a top perspective view from the front and one side showing the fastener storage sub-system of FIG. 24.

FIG. 26 is a schematic side view of a storage station forming a part of the storage sub-system of FIG. 24.

FIG. 27 is perspective view showing a socket mechanism for a fastener unit, the socket mechanism for temporarily retaining a wheel fastener in preparation for storage.

FIG. 28 is a front view of part of the fastener storage sub-system of FIG. 24 showing a fastener seat array and a fastener socket array at one stage in a fastener storage process.

FIG. 29 is a view corresponding to FIG. 28 showing the fastener seat array and the fastener socket array at a later stage in the fastener storage process.

FIG. 30 is a side view of a part of the fastener storage sub-system of FIG. 24 showing an initial stage in transferring fasteners from fastener system sockets to storage seats of the fastener storage sub-system.

FIG. 31 is a side view corresponding to FIG. 30 but showing a subsequent stage in transferring the fasteners.

FIG. 32 is a side view corresponding to FIG. 31 but showing a yet later stage in transferring the fasteners.

FIG. 33 is a perspective view from behind and one side of a part of the robot tool of FIG. 1 showing a tire pressure regulation sub-system according to an embodiment of the invention. FIG. 34 is a top perspective view from behind and one side showing the tire pressure regulation sub-system adjusted in preparation for connection to a wheel injection valve.

FIG. 35 is a scrap top perspective view from behind showing the tire pressure regulation sub-system connected to a wheel injection valve.

FIG. 36 is a top perspective view from the front and one side of a part of the robot tool of FIG. 1 showing a wheel balancing sub-system according to an embodiment of the invention.

FIG. 37 is a top perspective view from the back and the other side corresponding to FIG. 36.

FIG. 38 is a back view of the wheel balancing sub-system of FIG. 36 showing an operating arm in a first position.

FIG. 39 is a side view corresponding to FIG. 38.

FIG. 40 is a front view of the wheel balancing sub-system of FIG. 36 showing the operating arm in a second position.

FIG. 41 is a side view corresponding to FIG. 40.

FIG. 42 is a front view of the wheel balancing sub-system of FIG. 36 showing the operating arm in a third position.

FIG. 43 is a scrap perspective view showing the use of a gripper roller to rotate a wheel.

FIG. 43A is a perspective view showing the use of larger roller to rotate a wheel.

FIG. 43B is a scrap perspective view showing an assembly mounted at the end of the operating arm having an old balance weight remover, a rim cleaner, and a new balance weight applicator.

FIG. 43C shows the assembly of FIG. 43B to a larger scale.

FIG. 43D is a perspective view showing elements of the old balance weight remover of FIG. 43B.

FIG. 43E is a perspective view showing elements of the rim cleaner of FIG. 43B.

FIG. 43F is a perspective view showing elements of the new balance weight applicator of FIG. 43B.

FIG. 44 is an exploded perspective view showing part of a pressure plate assembly for the wheel balancing sub-system of FIG. 36.

FIG. 45 is an exploded perspective view showing part of a cone assembly for the wheel balancing sub-system of FIG. 36.

FIG. 45A is a scrap longitudinal sectional view showing the pressure plate assembly and the cone assembly used in clamping a wheel rim.

FIG. 45B is a scrap longitudinal sectional view showing in another embodiment, the pressure plate assembly comprising a cone block biased by a conical compression spring is placed inside the drum, and a drum on the other side are used in clamping a wheel rim.

FIG. 46 is a perspective view of a cap remover according to an embodiment of the invention, the cap remover forming part of the wheel balancing sub-system of FIG. 36 and being shown in a preparatory phase of operation.

FIG. 47 is a perspective view corresponding to FIG. 46 with the cap remover shown in a later phase of operation.

FIG. 48 is a schematic flow diagram of an overall control system for the robot tool according to an embodiment of the invention.

FIG. 49 is a schematic flow diagram of a carriage control module for the overall control system of FIG. 48, such module according to an embodiment of the invention.

FIG. 50 is a schematic flow diagram of tool support control module for the overall control system of FIG. 48, such module according to an embodiment of the invention.

FIG. 51 is a schematic flow diagram of vehicle lifting control module for the overall control system of FIG. 48, such module according to an embodiment of the invention.

FIG. 52 is a schematic flow diagram of a wheel alignment and access control module for the overall control system of FIG. 48, such module according to an embodiment of the invention.

FIG. 53 is a schematic flow diagram of a wheel gripping control module for the overall control system of FIG. 48, such module according to an embodiment of the invention.

FIG. 54 is a schematic flow diagram of a fastener storage control module for the overall control system of FIG. 48, such module according to an embodiment of the invention.

FIG. 55 is a schematic flow diagram of a tire inspection control module for the overall control system of FIG. 48, such module according to an embodiment of the invention.

FIG. 56 is a schematic flow diagram of part of a wheel balancing control module for the overall control system of FIG. 48, such module according to an embodiment of the invention.

FIG. 57 is a schematic flow diagram of part of another wheel balancing control module for the overall control system of FIG. 48, such module according to an embodiment of the invention.

FIG. 58 is a schematic flow diagram of a pressure regulator control module for the overall control system of FIG. 48, such module according to an embodiment of the invention.

FIG. 59A is a top perspective view from the back and one side of a part of the robot tool of FIG. 1, showing anchoring units and features according to an embodiment of the invention, wherein the robot tool anchoring units are in nested deactivated status.

FIG. 59B is a bottom perspective view from the bottom and one side of a part of the robot tool of FIG. 1, showing one of the locking slot and respective T bar of the anchoring units according to an embodiment of the invention, wherein the T bar orientation is parallel to the locking slot orientation and inserted into said slot.

FIG. 59C is a bottom perspective view from the bottom and one side of a part of the robot tool of FIG. 1, showing one of the locking slot and respective T bar of the anchoring units according to an embodiment of the invention, wherein the T-bar is parallel to the slot.

FIG. 59D is a bottom perspective view from the bottom and one side of a part of the robot tool of FIG. 1, showing one of the locking slot and respective T bar of the anchoring units according to an embodiment of the invention, wherein the T-bar and the slot are oriented perpendicularly.

### DETAILED DESCRIPTION OF THE INVENTION INCLUDING THE PRESENTLY PREFERRED EMBODIMENTS

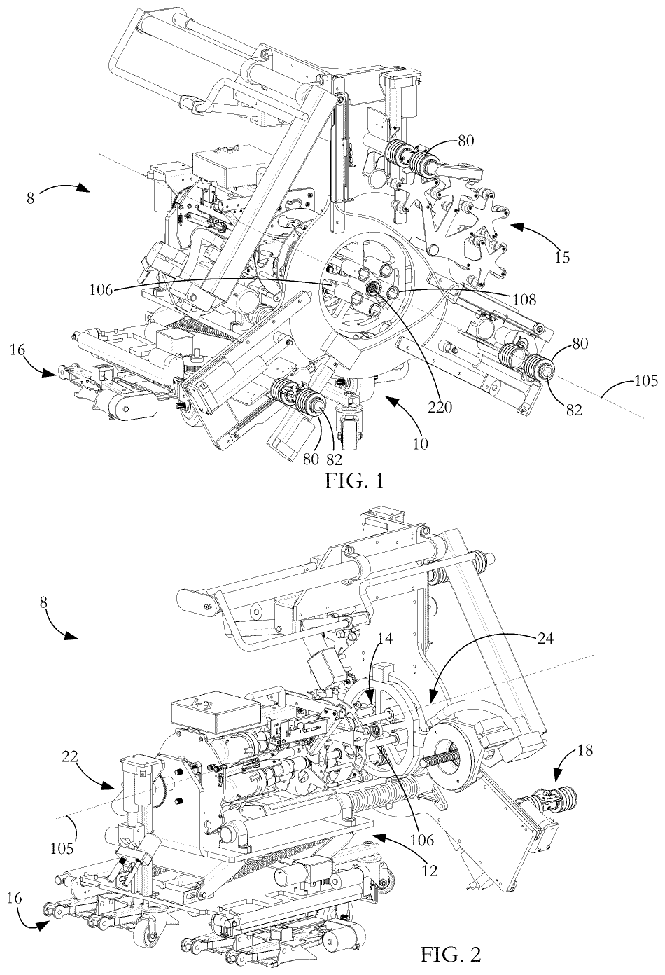

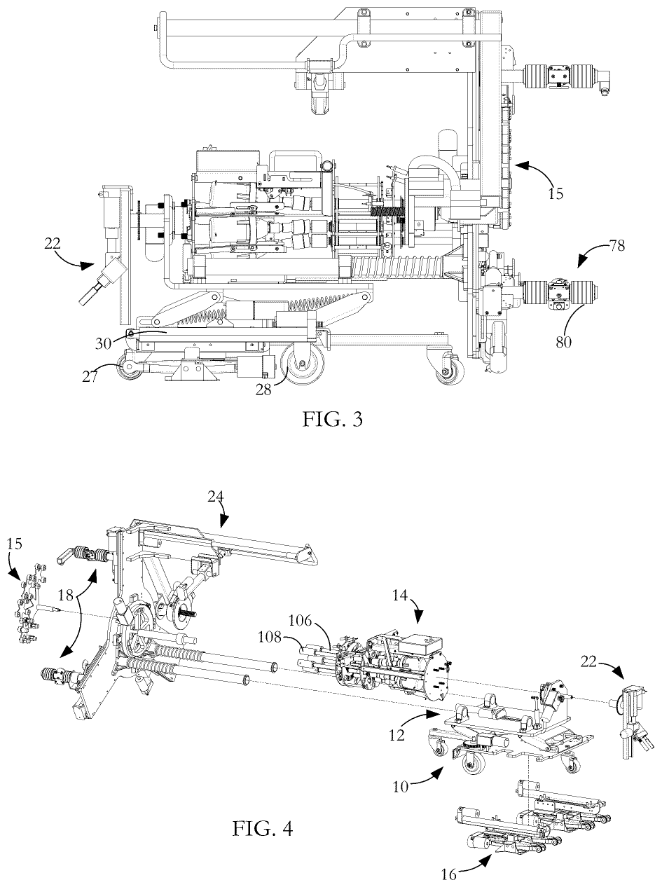

Referring to FIGS. 1, 2, 3 and 4, a robot tool 8 for servicing a vehicle wheel has several wheel servicing sub-systems as follows:
a chassis sub-system 10;
a tool support sub-system 12;
a fastener detaching/attaching sub-system 14;
a fastener storage sub-system 15;
a jacking sub-system 16;
a gripper sub-system 18;
a tire inspection sub-system 20;
a tire pressure sub-system 22;
a wheel balancing sub-system 24.

Each of the wheel servicing sub-systems has one or more interface parts which under a system control is automatically engageable with corresponding wheel interface parts, these engagements permitting automatic operation of the respective wheel servicing sub-system to service the vehicle wheel. In one embodiment of the invention, when a vehicle wheel requires servicing, the following exemplary sequence of steps is undertaken.

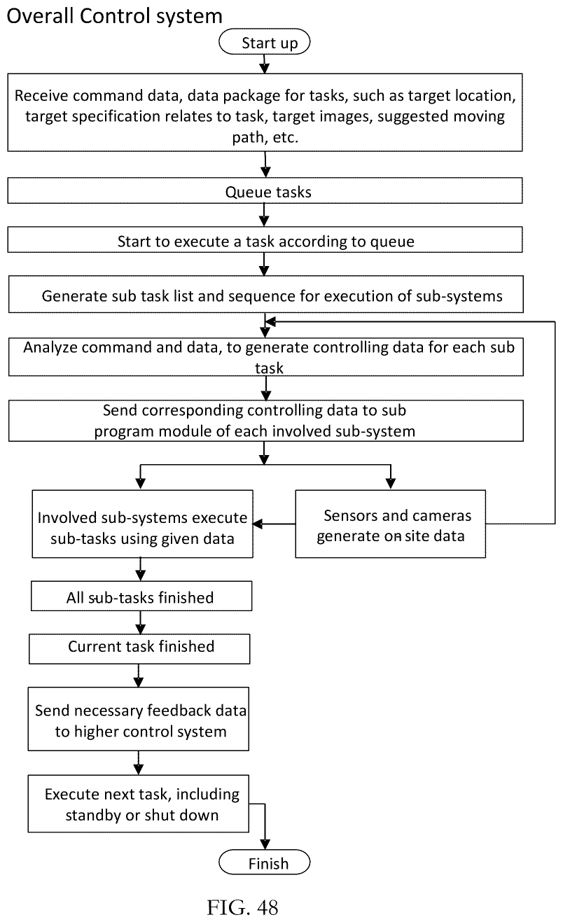

FIG. 48 is a schematic flow diagram of an overall control system for the robot tool according to an embodiment of the invention. As schematically depicted in FIG. 48, an on-board control system at the robot tool receives instructions identifying work to be done from a control center through a wireless network or other communication channel. Subsequently, all servicing operations are performed according to the received instructions without manual intervention other than to investigate issues which are reported 6 resulting either in updating to the instructions issued to the control system or a trouble shooting manual intervention. Initial instructions identify where the work is to be done, such as by identifying the location of the target vehicle (for example, as GPS coordinates) or by a route to the vehicle, providing data for the target vehicle (such as model, year, color, license plate number and shape, wheel service history, vehicle exterior, wheel dimension, torque standard) and providing associated images, such as those of the vehicle body, jack point positions, etc. Once within an autonomous operational range of the target vehicle, the robot tool moves to a position close to the target vehicle, according to a path identified in the instructions and/or a path calculated by the robot as modified/updated by images from its cameras as it moves under the control of a machine vision system. As the robot approaches the target vehicle, vehicle appearance characteristics are monitored and corresponding data is checked against data included in the instructions to confirm that the approached vehicle is indeed the target vehicle. According to the control center command, the robot controller develops a detailed job list and sequence; e.g., sequence of jack points to be lifted. Cameras at the robot work with the control system to identify the vehicle orientation and location of the wheel to be removed and the tool moves to the appropriate side of and position along the vehicle. As shown in FIG. 48, control outputs are issued from the control system to individual sub-systems as and when they are deployed. Typically, these include outputs to switches, motors and other actuators. As the sub-systems operate, outputs are sent from the sub-systems to the control system reporting on the progress of the sub-system operation. Typically, these include camera and sensor outputs which are processed in the control system. The control system includes a comprehensive machine vision sub-system whereby images of a wheel part being serviced and the sub-system doing the servicing are analyzed and used, either alone or in conjunction with other resource data, to effect real-time control adjustment to the sub-system. Cameras and their positions are not shown in the figures but it will be understood that they are mounted wherever expedient to do so.

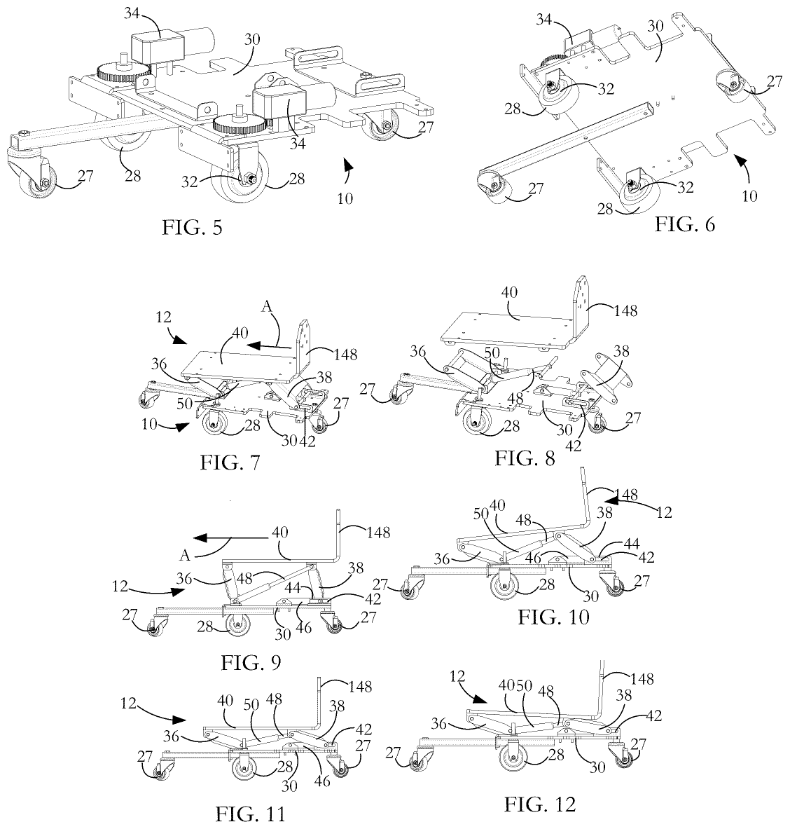

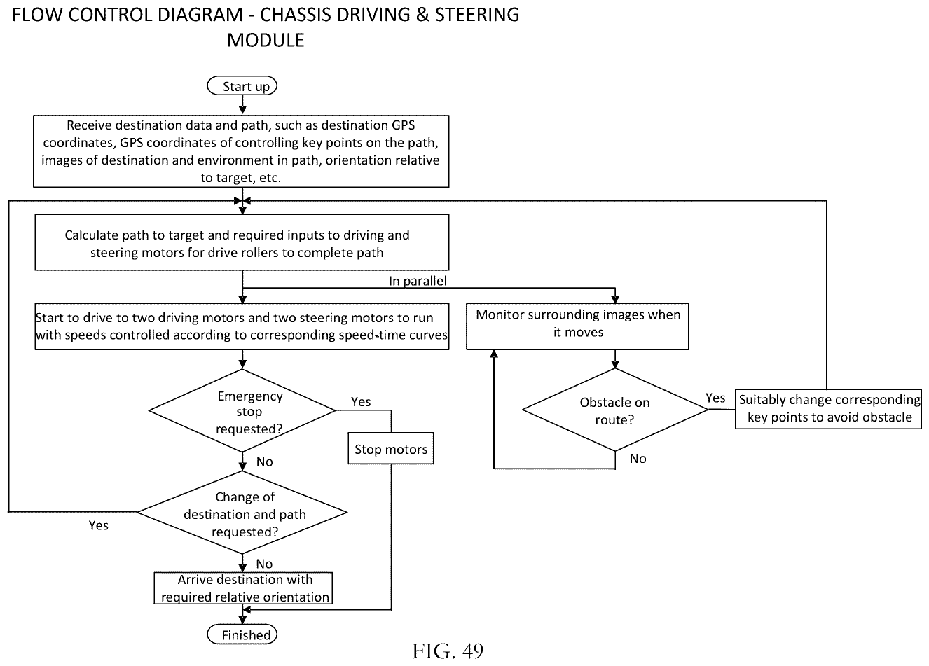

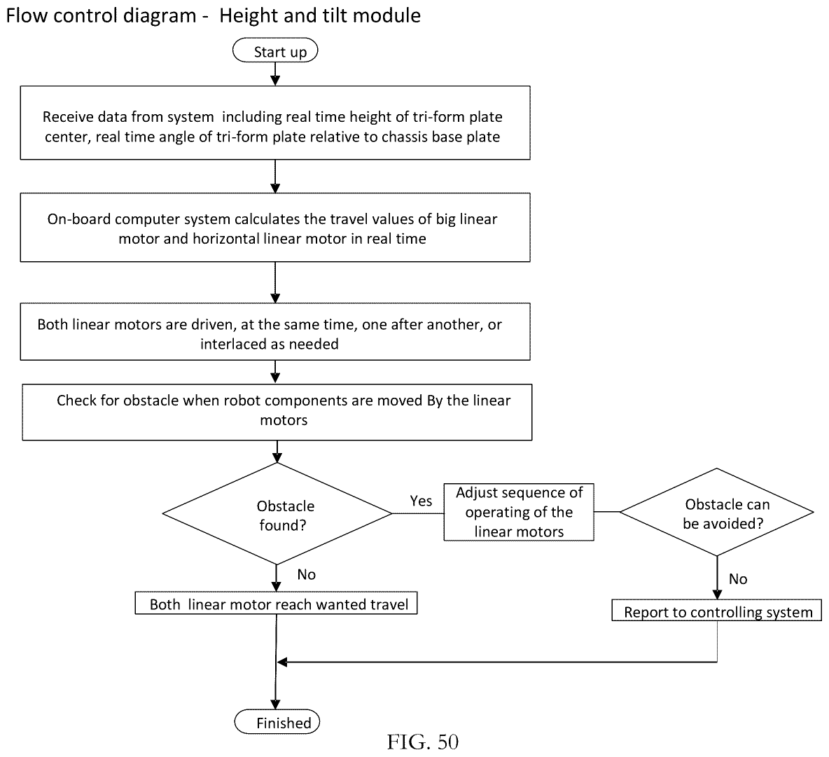

Referring to FIGS. 5 and 6, primary movement of the robot tool 8 is by means of a wheeled chassis 10 which is adapted to move the robot tool on a supporting surface such as the ground. On-board chassis drives are coordinated to effect rectilinear, curvilinear and spin motion of the chassis on the supporting surface. A chassis frame 30 has four wheels or rollers 27, 28 mounted in a diamond array. Idler swivel wheels or casters 27 are mounted to the frame 30 at front and back corners of the array and drive wheels or rollers 28 are mounted to the frame 30 at opposed side corners of the array. Control to the drive wheels is used to orientate horizontal axes of rotation into any of a range of relationships, both parallel and non-parallel. The drive wheels are independently driven by motors 32 at the same or different speeds or rotary directions to move the tool in any of a range of directions and along any of a range of paths. The drive rollers 28 are also independently mounted on vertical axes and can be rotated independently to change the roller drive direction by rotary motors 34 to provide a further degree of freedom for independent movement of the drive wheels. The design allows translational movement in any direction parallel to the plane of the support surface, allows the robot tool to spin about any vertical axis, and allows any combination of these movements. This design provides a highly flexible and comprehensive translational and spin movements of the robot tool, which is valuable for operation in a confined space. FIG. 49 is a schematic flow diagram of a carriage control module.

As shown in FIGS. 7 to 12, mounted on the wheeled chassis by means of front struts 36 and rear struts 38 is a tool support plate 40. Top and bottom ends of the struts 36, 38 are pivotally mounted at the support plate 40 and the chassis frame 30 respectively. The bottom ends of the rear struts 38 are slidably mounted in horizontal slots 42 on linear flanges 44 integral with the chassis frame 30, the flanges 44 extending parallel to a fore-aft chassis axis, A. Linear motors 46 are operable to move the bottom ends of strut 38 between stop positions along the slots 42. End of rod 48 of linear motor 50 is pivotally mounted to upper ends of the rear struts 38 and another end of the linear motor body 50 is pivotally mounted to lower ends of the front struts 36. Linear motor 50 is operable to alter the spacing between the rear strut upper ends and the front strut lower ends. Coordinated operation of the motors 46, 50 is used to raise, lower, forward tilt or backward tilt the support plate 40 and the supported tool sub-systems. As shown in FIGS. 9 to 12, operation of the motors 46, 50 is used to obtain, within a permitted range, any combination of height change and tilt of the support plate 40 in any desired sequence of height adjustment and tilt change increments. The sequencing is important in view of the compact arrangement of the wheel servicing sub-systems and the need to control movement of the tool and its sub-systems without blockage or collision between sub-system components. A particular combination of tilt angle θ and height H corresponds to a combination of a displacement L1 of motor 46 and a displacement L2 of motor 50. For required values of θ, H, the control system calculates the corresponding values of L1 and L2 and sets displacement of the motors either in a one-time coordinated activation, or in a sequence of activation steps. The primary functional requirement for the tool support sub-system is to enable height change of the front end of the fastener sub-system while enabling tilt through a range of angles at any height in such a way that the front of the fastener sub-system is suitably positioned in front of the chassis such that the gripper sub-system is not blocked by the chassis. The lift and tilt function can be attained by variations of the illustrated mechanism such as, for example one or more vertical linear motors with bottoms of the linear motors attached to the chassis frame and driven rods pivotally and slidably mounted to the underside of the support plate. These and any other linear or rotary drives used in the robot tool can be equipped to measure displacement for use in subsequent control. Alternatively, or in addition, a height and tilt measuring mechanism can be mounted on the support plate. FIG. 50 is a schematic flow diagram of tool support control module.

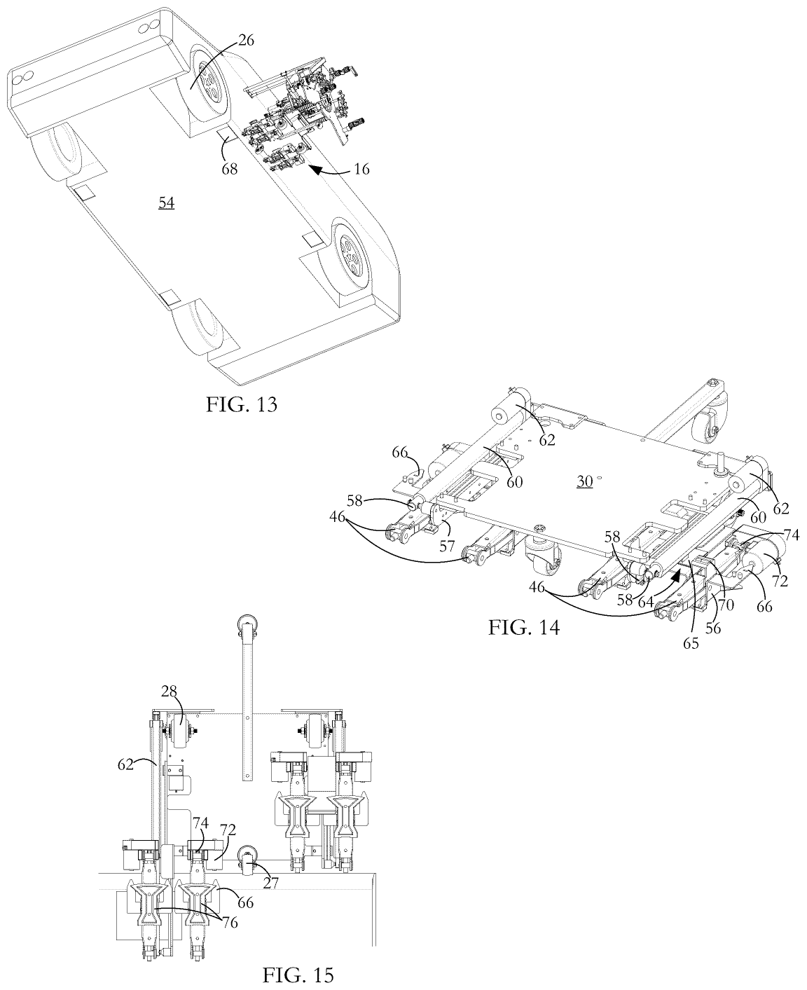

As shown in FIGS. 13 to 18, suspended from the back of the chassis frame 30 is a jacking sub-system 16 comprising four jacks 52, each of which is independently deployable for lifting a part of a vehicle 54. A pair of jacks 52 is carried in each of a pair of docking stations 56. Each docking station 56 is mounted on a slidable member 57 which is mounted to a slide suspension member 58 attached to the carriage. The slide arrangement is such that each of the docking stations 56 can be driven out from the carriage in a direction parallel to the operational axis and then returned to the carriage. For this purpose, a linear motor 62 has its actuating rod 61 attached to the slidable member and sliding in motor barrel 60. Each carriage has housings 64 each of which can receive a pointed blade 66 on the jack 52 whereby a jack is mounted on the docking station in standby mode but can be separated out of its housing 64 when deployed. The housings have upper and lower guidance tabs 65 to guide a pointed blade 66 into a housing 64.

When a particular jack 52 is to be deployed to lift a vehicle 54, the mobile chassis 10 is turned so that the docking stations 56 face towards the vehicle 54. Based on control system review of vehicle body jack point position data, the chassis position is adjusted to bring an available one of the jacks 53 roughly abreast of the expected position of a target vehicle jack point 68. On-board cameras generate images of the vehicle underside and these are analyzed working with the machine vision system to identify the exact position of the target jack point 68. In one embodiment of the jacking sub-system 16, for example, cameras are located at front, rear, left and right corners of the chassis frame 30, at the docking stations 56 and at each jack 52, with point laser light sources being located at the center of each jack lifting head 70.

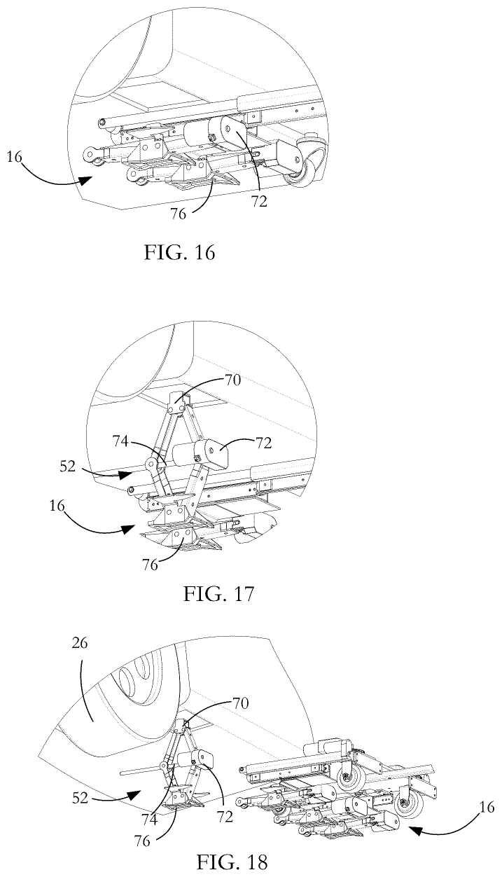

In a coordinated operation, the linear motor of the selected docking station 56 is operated to slide the docking station 56 out from the carriage so that the jack lifting head 70 of the selected jack is moved directly under the target vehicle jack point (FIG. 16). Rotary mmotor 72 on the deployed jack 52 is then operated to turn screw drive 74 to provide a scissors lifting action to the positioned jack to raise the jack lifting head to engage and lift the overlying vehicle part (FIG. 17). After the vehicle part is lifted, part of the vehicle weight is supported by the deployed jack with the jack base pressed against the ground or other support surface. The robot tool 8 is disconnected from the deployed jack 52 simply by driving the chassis 10 rearwardly away from the vehicle 54 so that the pointed blade 66 slides out of the associated housing 64 on the docking station (FIG. 18). The mobile chassis 10 can then be driven to a position near another vehicle jack point either on the same side of the vehicle or on its other side where a second jack 52 can be deployed in the same way. To retrieve a jack from the vehicle and to remount it on the robot tool when a particular service phase is complete, a reverse sequence is adopted.

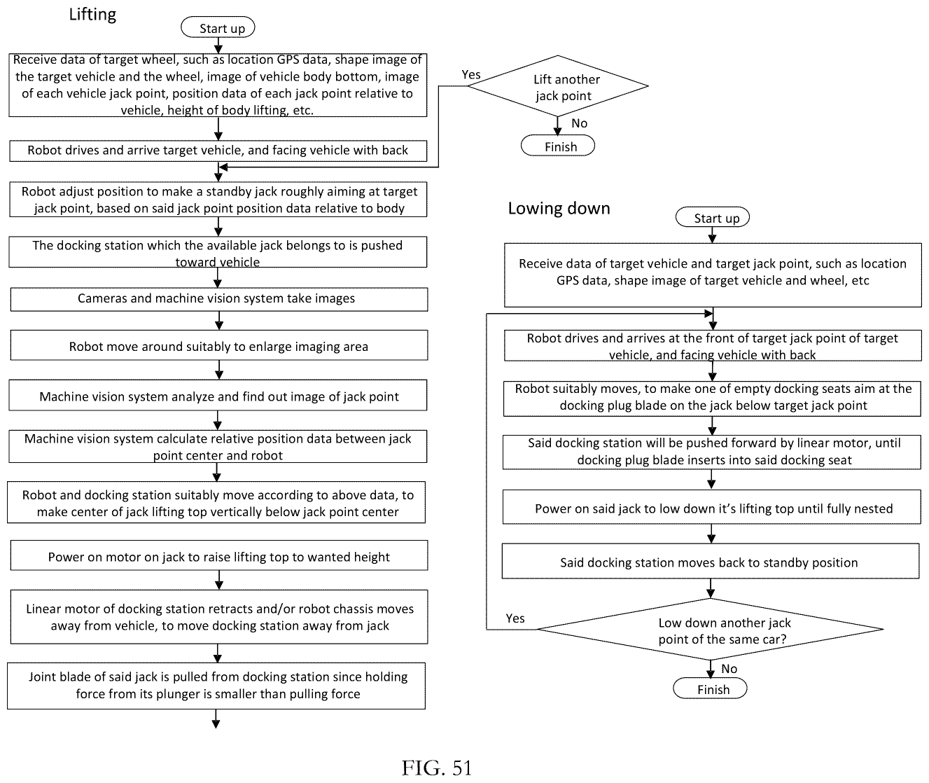

To lift the vehicle for wheel removal, the robot moves to a suitable position beside the closest vehicle jack point and turns so that the back of the tool faces towards the vehicle. One of the two docking stations 56 is then slid along the slide suspension member 58 towards the vehicle 54. Cameras on the docking station 56 and jacks 52 scan images of the vehicle underside as the jacks 52 approach an operable position. The machine vision system checks the scanned images against stored images of the desired jack point, and adjusts the selected jack position as needed until a match is found. Movements of the wheeled chassis and the docking station 56 are coordinated to bring the support plate of one of the jacks into vertical alignment with the center of a vehicle jack point. Vertical alignment is determined by coincidence of a laser point directed upwardly from a laser source located at the jack center to a vehicle jack point. Jack motor is then powered on to lift the overlying part of the vehicle to a height determined in the instructions and monitored by the extent of scissors movement of the jack. Cameras monitor clearance between the treaded wheel surface and ground or other support surface. Once the vehicle is lifted to a desired height so that the required clearance between vehicle and ground exists, the jack motor is powered off. The docking station drive and the chassis drive wheels then operate to retract the docking station 56 and to roll the tool away from the vehicle. Because the deployed jack supports the vehicle, the bottom of the jack is pressed hard against the ground so that, as the robot tool rolls back, blade 66 slides out of the docking station housing 64. According to the control instructions, any one or more of the remaining jacks is deployed to lift the vehicle at another jack point or the tool is moved to another site to lift another vehicle. The robot tool is now ready for its next servicing task. In an alternative sequence a machine vision system directly calculates the coordinates of target vehicle jack point relative to the robot tool and the tool is maneuvered to bring the jack lifting head to a target jack point. Once replacement or other servicing of the wheel is completed, the jack is removed by substantially reversing the above sequence of steps. FIG. 51 is a schematic flow diagram of vehicle lifting control module for the overall control system of FIG. 48, such module according to an embodiment of the invention.

There are a number of servicing actions that can be performed on a wheel while it remains mounted on a vehicle. If an on-vehicle service action cannot be performed, the robot tool removes the wheel from the vehicle hub to prepare for servicing by using a fastener engaging/disengaging sub-system (“fastener unit”) such as that disclosed in co-pending U.S. patent application Ser. No. 16/104,792. When a vehicle is lifted and a wheel leaves the ground, the wheel may free to rotate, or may be fixed against rotation by the vehicle transmission unit or parking brake. This can be identified from received vehicle data. In a variation of the jack procedure for a vehicle having a freely rotatable wheel, lifting and lowering are interrupted at a point where the jack lifting head and the vehicle jack point are engaged and sufficient residual weight is borne by the support surface that fasteners clamping the wheel to the hub can be preliminarily untightened (wheel detachment) or tightened (wheel attachment) without spinning the wheel. Once preliminarily untightened or tightened, the jack raising or lowering procedure continues. In other circumstances, a wheel may be detected to be sufficiently braked or otherwise prevented from turning that no interruption in the jacking procedure is necessary.

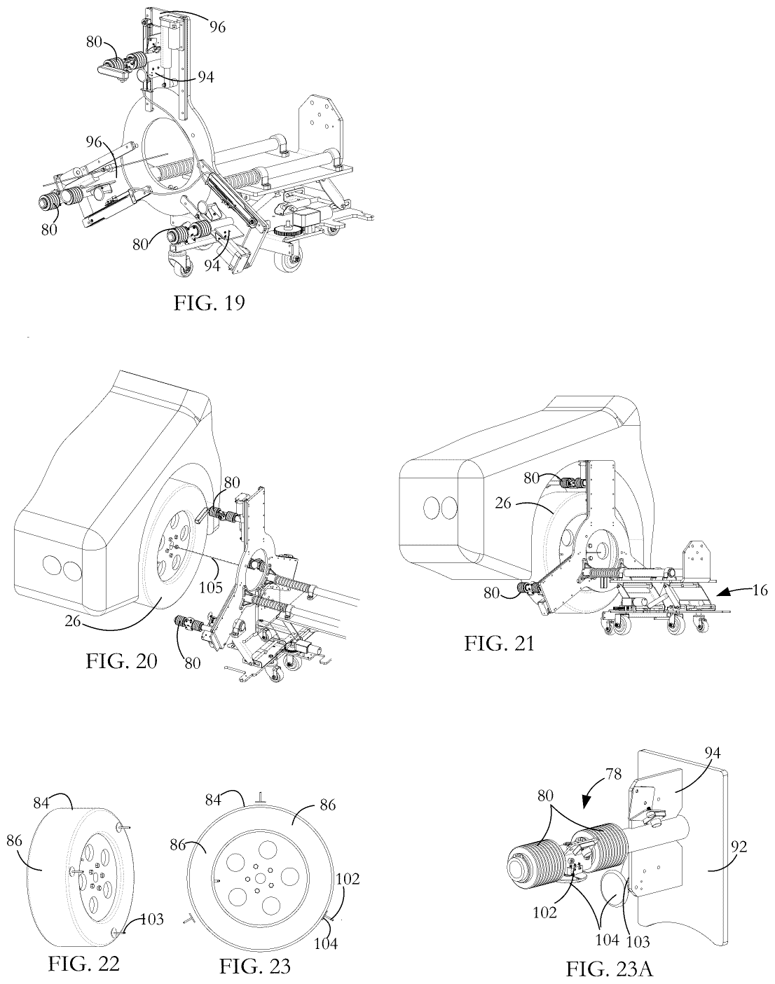

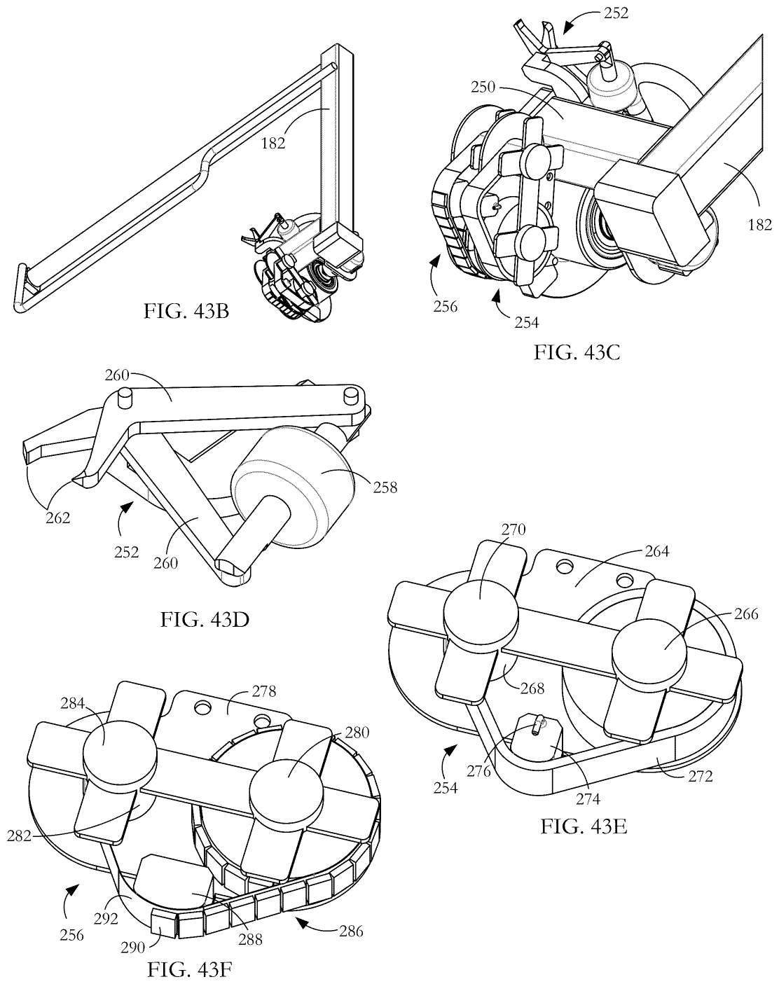

After a vehicle is raised by a jack to lift a wheel off the ground or other support surface, the wheel is removed and either serviced and remounted or taken away and replaced by a previously serviced, spare or new wheel. In both cases, as shown in FIGS. 19 to 23, the wheel 26 is automatically gripped by the gripper sub-system in preparation for removal. As shown in FIGS. 19 and 20, three grippers 78 are mounted in an equispaced, circular array at the front of the robot tool. Each gripper has a pair of cylindrical rollers 80 coaxially mounted on a shaft 82 extending generally parallel to the tool operational axis. More than one roller 80 is used at each gripper 78 in order better to match or conform the gripper to the outer tread surface 84 of tire 26. Depending on original design and wear, the section of the tread surface 84 may be curved or one side of the tread surface may be more worn than the other side. By using two or more rollers 80, contact is improved. In other alternatives, the two rollers are cone-shaped with a small taper angle or the rollers are mounted with a flexible connection between them allowing the rollers to have rotational axes that are not completely aligned. In each of the multi-roller gripping units previously described, first and second rollers are mounted with respective axes of rotation within a common plane containing the robot tool operational axis. In operation, the rollers are moved to bear against the wheel tread surface at respective regions of the surface which are intersected by the common plane and which are adjacent to one another. The rollers have a surface layer of resilient material to enhance the grip interface between the grippers 78 and the tire tread surface 84. As shown in FIG. 43, a roller 80 on least one of the grippers is connected to rotary motor 90 which, when needed, is driven to rotate the connected roller on that gripper 78 resulting in counter-rotation of the gripped wheel 26. As will be described presently, the wheel can be rotated slowly to enable tire inspection and related servicing or can be driven at higher speed for assessing and correcting wheel imbalance.

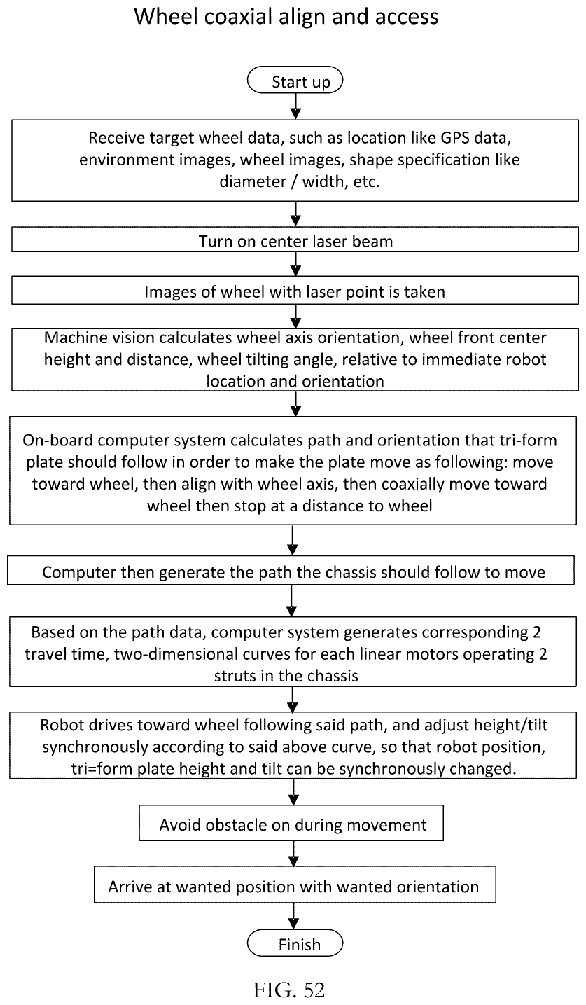

One end of each shaft 82 is fixed to a respective carriage 92 having shaft-supporting flanges or fins 94. Each carriage 92 is mounted for radial reciprocal sliding movement along respective frames 96 mounted on spokes of a tri-form plate 98. Each of the three carriages 92 is independently driven by respective linear motors 100 to move the grippers 78 in a coordinated manner to increase or decrease the radius of their circular array. The circle radius is increased so that a wheel 26 can be accommodated inside the circular array and is reduced to move grippers 78 against the tire tread surface 84 to grip the tire 86. In one embodiment, the three linear motors 100 have internal displacement sensors and the three grippers 78 are moved independently to grip the wheel 26 with displacement from a coordinated start positions being measured by the sensors. The control system calculates the wheel axis position and then adjusts the position of the tool operational axis to obtain alignment. In an alternative embodiment in which the linear motors lack internal displacement sensors, Bowden cables are used to implement a ‘compare’ function. Two of the three carriages are subordinate and are connected to the ‘main’ carriage by the cables. Movement of the cables transmits the subordinate carriage displacements to a comparator device at the main carriage where the three displacements are compared. If one displacement lags, drive to the other two carriages is stopped until the displacements are equalized. In this way, the circular array of grippers is incrementally adjusted to maintain the center of the array in coaxial alignment with the tool operational axis. FIG. 52 is a schematic flow diagram of a wheel alignment and access control module.

As shown in FIGS. 23 and 23A, tread surface contact sensors 102 mounted between rollers 80 of each gripper 78 are used to monitor the direction of any offset of the wheel center axis relative to the tool operational axis. If, during radially inward movement of sensor pads 104, only one tread surface contact sensor 102 is activated, this means that the wheel 26 is closer to the associated gripper 78 than to the other two grippers. In response, the control system moves the operational axis to equalize spacing of the grippers 78 from the tread surface 84 while progressively moving the grippers 78 towards the tread surface 84 to effect gripping. If there were direct contact between the head of a sensor 102 and the tire 86 of a spinning wheel, the sensor 102 could be damaged. Sensor pad 104, while absorbing the dynamic impact of a spinning wheel, triggers the tread surface contact sensor 102 when contact between the pad and the wheel surface 84 is made. Similar sensors 103 and transfer pads 104 are mounted on gripper carriage 92 and a similar method is used as the gripper sub-system is moved towards the tire outside sidewall as shown in FIG. 22. Tire sidewall sensors 103 are activated by the approach and contact of the tool to the sidewall when contact is established at sidewall sensor pads, the contact being such as to trigger the tire sidewall contact sensor when contact between the sidewall transfer pads and the wheel sidewall is made. In fact, the tire sidewall maneuver is performed before the tire tread surface maneuver. This incremental approach technique and analysis can alternatively be monitored using other types of sensors such as touchless (optical, ultrasonic, etc.) approach and distance sensors.

In operation (FIG. 20) the robot tool drives to a set-up position in front of the target wheel 26 and projects a centering laser beam 105 along the operational axis to the wheel. At the same time, the machine vision system analyzes an image of the wheel and laser point and calculates the center offset between the laser point and the wheel center and calculates also the difference in inclination between the wheel axis and the operational axis. This is used to calculate an approach path and orientation of tri-form plate 98. Corresponding drives to the chassis and support plate are applied to move the tri-form plate 98 towards the wheel align and to align the tool operational axis with the wheel axis. As shown in FIG. 21, as the gripper assembly slides closer to the wheel, the grippers are moved radially as deemed necessary from the machine vision system interpreting wheel and vehicle body stored and image data to allow the grippers to be inserted into the cavity between the wheel and the vehicle body. A similar sequence can be used to approach and grip a wheel that is not vehicle mounted such as a new wheel stacked in a dispensing arrangement. As shown in FIG. 21, according to the offset and inclination differences between the robot operational axis and the wheel axis, corrections in tool operational axis position and inclination are made to obtain a rough alignment of the tool operational axis with the wheel axis.

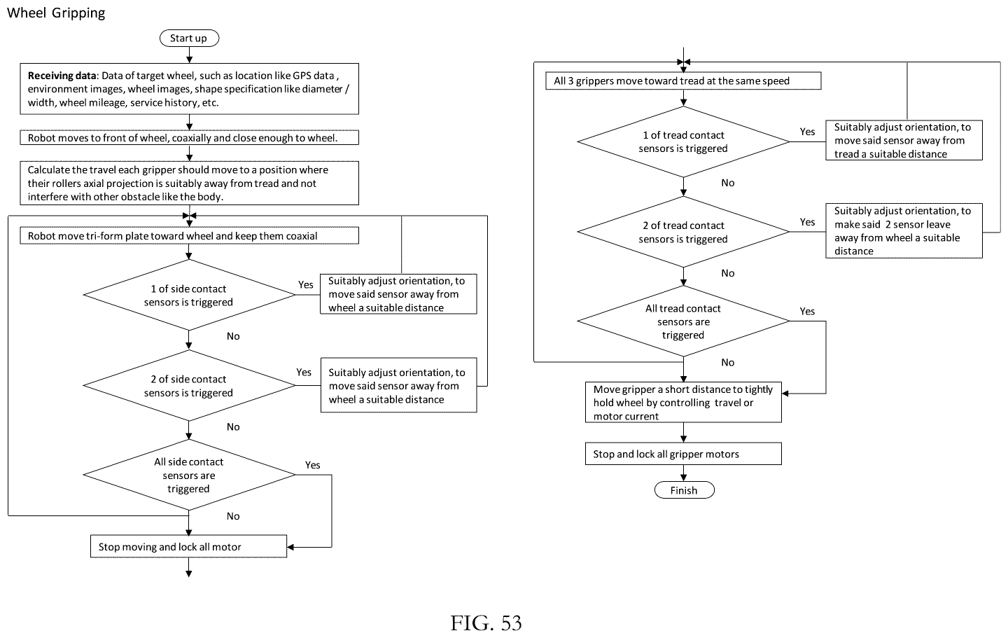

More accurate positioning is then achieved using three side surface access sensors 103, the ends of which are shown on FIG. 22 and the three tread surface access sensors 102, the ends of which are shown on FIG. 23. As shown in FIG. 22, as the tool approaches, one (or two) side surface sensor 103 will be triggered first. Forward motion of the robot towards the tire continues but with a suitable tool orientation adjustment to restore a small spacing between the triggered side surface sensor and the side wall. Axis alignment is achieved when all three side sensors are triggered at which time the forward movement of the tool is stopped. While the tool is being positioned relative to the tire side wall, the three grippers in the wheel cavity are moving radially inwardly towards the treaded surface (FIG. 23). Again, one (or two) tread access sensor 102 will be triggered first. Inward motion of the grippers continues but with a suitable tool adjustment to maintain a small spacing between the triggered tread access sensor and the tread surface. Proper positioning of the grippers is achieved when all three tread access sensors 102 are triggered. At this time, the grippers are moved a further short controlled travel to hold the wheel tightly enough for subsequent servicing operations, including wheel removal. FIG. 53 is a schematic flow diagram of a wheel gripping control module.

Co-pending U.S. application Ser. No. 16/104,792 describes the use of a robot wheel servicing tool to attach and detach wheel fasteners. Referring to FIGS. 1 to 4, an exemplary fastener loader unit 14 is mounted on support plate 40 and has a set of parallel spindles 106, each rotatable about its longitudinal axis, the spindles being circularly arrayed. Sockets 108 at the spindle front ends are adapted to hold and rotate threaded fasteners 110 such as lug nuts configured for screw engagement with corresponding threaded fasteners such as threaded studs mounted on a vehicle mounted hub member. Rear ends of the spindles 106 are attached by universal joints 114 to motors 116 for rotating the spindles 106 about their axes. An adjustment mechanism 118 is used for synchronously altering the ‘spread’ of the spindle axes. In operation, for removing a wheel 26, the fastener loader unit 14 is operable to automatically place sockets 108 over the fasteners 110 of a vehicle-attached wheel and to unscrew the fasteners from complementary fasteners at the wheel hub. Similarly, for mounting a wheel, the fastener unit is operable to hold and automatically screw fasteners onto corresponding fasteners on the wheel hub. The fastener loader unit 14 must be moved between different locations and must be oriented at different angles in order to effect fastener removal or attachment. As described in U.S. patent application Ser. No. 16/104,792, some of these movements are automatically effected through the aegis of drives and mounting arrangements within the fastener loader unit itself. The fastener unit is mounted on support plate 40 and other movements of the fastener loader unit 14 are effected through manipulation of the support plate.

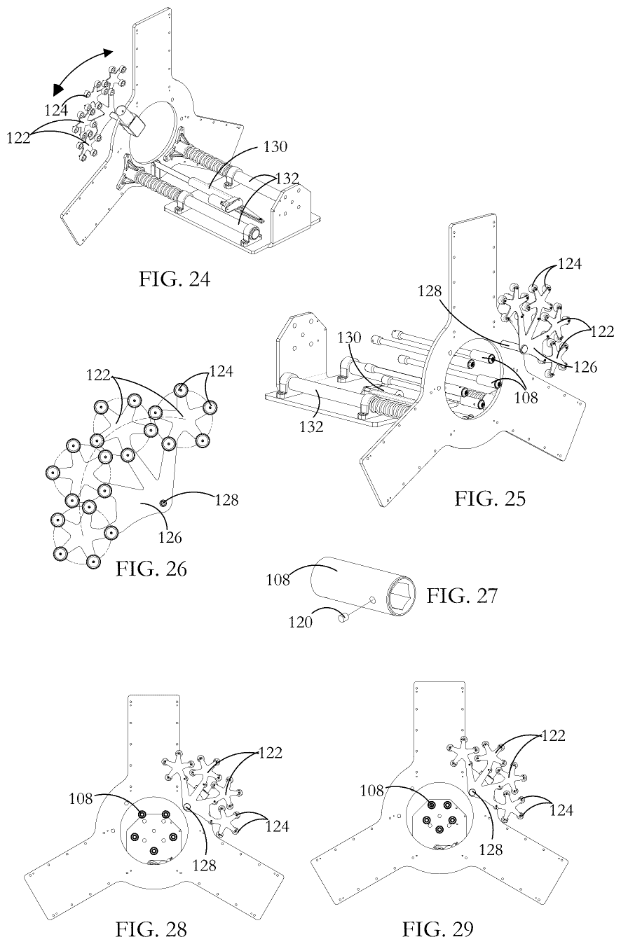

Once the wheel 26 is fully gripped, servicing of the wheel is performed by the robot tool with the wheel either on-or off-vehicle. In the latter case, the fastener unit 14 is deployed to remove fasteners such as lug nuts which are then stored by a fastener storage sub-system 15 which is shown with reference to FIGS. 24 to 32. Following removal from their wheel attachment positions, the fasteners 110 are initially held in the fastener sockets 108. As shown in FIG. 27, a fastener 110 is held in its socket 108 by a small permanent magnet 120 integrated into the socket barrel. As shown by FIGS. 28 and 29, the sockets 108 are collectively radially moved from a start position (FIG. 28) where they have just been untightened to a finish position (FIG. 29) where the fasteners 110 are in a circular array having a predefined storage-ready radius. As shown in FIG. 26, four storage stations 122 of the storage sub-system 15 each have five lug nut storage seats, the seats of each storage station being mounted in a circular array of the storage-ready radius. The storage stations 122 are mounted on plate 126 which is angularly rotatable around a shaft 128 attached to tri-form plate 98. The distance from the center axis of each 5-store seat array to the pivot point is the same for each storage station. In this way, any one of the storage stations can be pivoted into a position where its center axis is aligned with the center axis of the socket array. Plate 126 is pivoted to a position in which the circular array of storage seats 124 at selectable storage station 122 is aligned with the circular array of sockets 108. The arrangement of fasteners is such that, when at the pivoted position, the seats of the storage seat array of the selected storage station are aligned with respective sockets of the socket array.

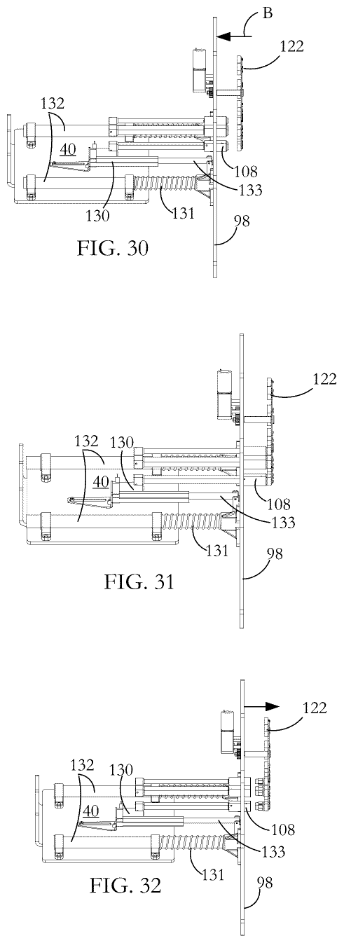

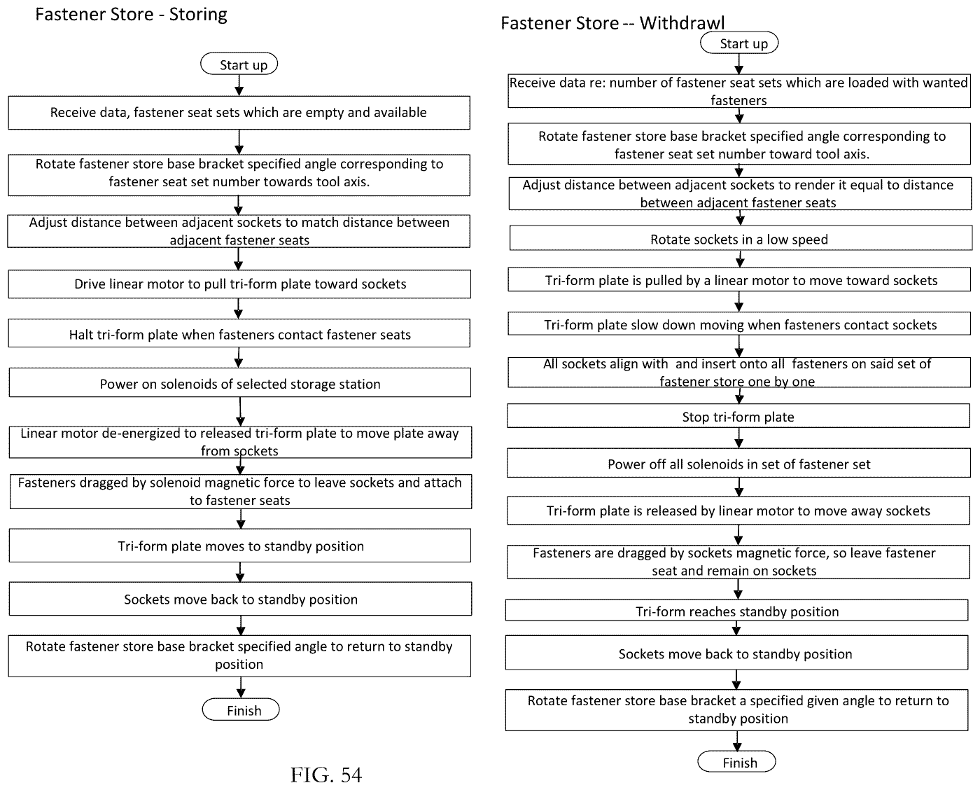

As shown by FIGS. 30 to 32, the tri-form plate 98 is mounted on parallel shafts 132 which are slidably mounted on support plate 40. The plate 98 can be driven in the direction B by rod 133 of linear motor 130 to bring storage stations 122 toward the sockets 108, until fasteners 110 on a selected held in the sockets 108 contact and engage respective storage seats 124 (FIG. 31). Each storage seat 124 has an associated electromagnet that is used to pull a fastener 110 from a socket 108 into a storage position after the storage seat 124 engages the fastener. Linear motor 130 is then released and springs 131 drive the tri-form plate back so that fasteners 110 are pulled out of sockets 108 and remain locked onto the storage seats 124. The plate 126 is then pivoted around shaft 128 to lodge the storage stations 122 at a standby position. The electromagnets are maintained in a powered state to ensure the fasteners do not drop out of their storage seats 124 pending their reuse to mount a wheel. In an alternative embodiment, permanent magnets are located at each of the storage seats and electromagnets are located at the tool sockets. In a further alternative, electromagnets are installed at both the storage seats and the tool sockets. In one embodiment, the spacing of adjacent seats 124 is set to the spacing of adjacent tool sockets when the sockets are fully radially retracted. Optionally, the adjacent seat spacing is set to any value within the permitted range of adjacent tool socket spacing and, when transferring fasteners, the radial positions of the tool sockets are adjusted to match the fixed pattern of the storage seats. The quantity of storage seats at each station can be changed for different wheel configurations by changing the storage stations or using a different configuration of pivotal plate 126. Also, the quantity of storage stations can be changed depending on application demands. While a 20-lug nut store (4 wheels with 5 lug nuts per wheel) is illustrated, tool storage capacity can differ as between different models to meet application needs; for example, 4 and 5 fasteners for many automobiles and up to 12 or more for trucks and semi-trailers. For example, for rapid servicing, a first vehicle may have all wheels removed and be waiting for new wheels. In the wait period, the robot can be used to service another vehicle and so would have a larger storage capacity. When mounting a wheel, stored lug nuts are removed from storage stations and used to fasten a wheel to a vehicle wheel hub in essentially a reverse procedure. In another fastener storage embodiment, each storage station is mounted to a plate as a circular array, the arrays being concentric. When the socket-to-storage fastener transfer is to be made, the fastener loader sub-system spindles are spread so that the socket circular array matches the selected one of the storage seat circular arrays. FIG. 54 is a schematic flow diagram of a fastener storage control module.

A wheel 26 that is rotatable on its hub can be serviced while the wheel remains mounted on the vehicle. Free on-vehicle rotation may be effected by powering the gripper motor to turn the powered gripper about its operational axis and so counter-rotate the wheel. Alternatively, if free rotation is not possible, the vehicle's central power unit may be operated to drive the wheel. If on-vehicle rotation is not possible at all or if the wheel needs to be detached from the vehicle for other purposes, it is removed as described above. Whether on-vehicle or off, the tire 44 is gripped by the gripper sub-system 18 to bring components of the tire inspection sub-system 20 to operational positions adjacent the tire 44 in preparation for inspection.

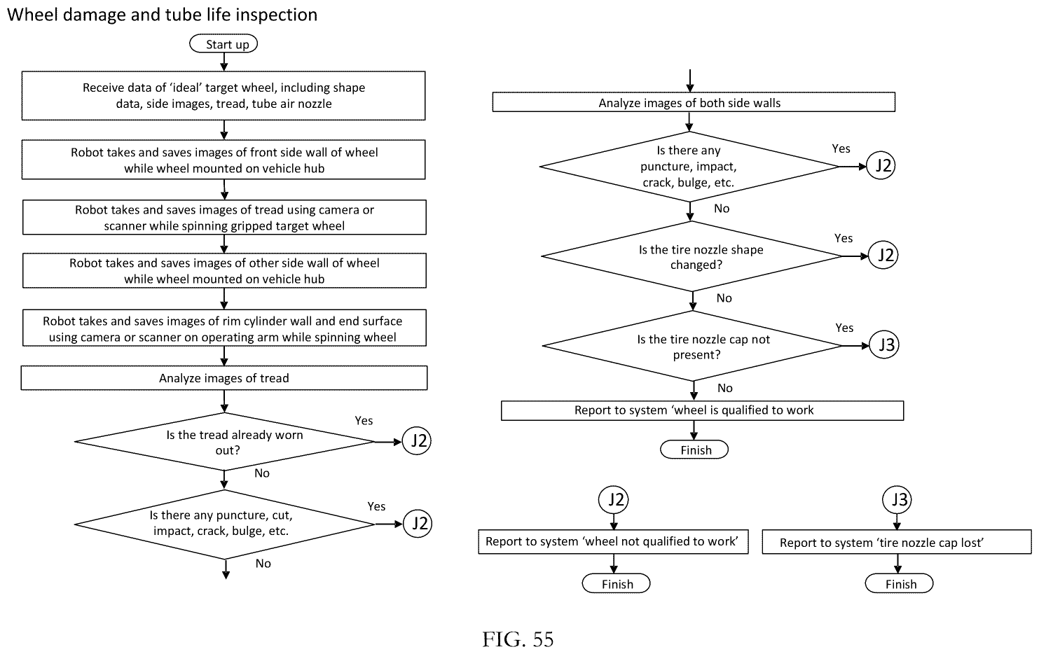

After a wheel 26 is successfully gripped by the grippers 78, it is driven to rotate at a slow speed or is driven intermittently to capture tire data, the condition of the tire and its tread being monitored by light-camera combinations mounted on or near the grippers 78 and forming part of a machine vision system, itself a part of the control system. Captured images of a wheel 26 are automatically compared to stored images and other data to determine and log the presence and location of, for example, bulges, nails, stones, scratches, and cuts. In addition, the depth of remaining tread, whether the tread wear is uniform, and whether the tread is damaged are similarly analyzed. Light-camera combinations for monitoring tread are co-mounted with tread contact sensors 102. When a wheel is gripped, the inner wall of the tire—i.e., the wall nearer the vehicle is not easily accessible. To monitor inner tire wall condition, tire wall camera 134 is used, the camera being shown in standby position in FIG. 20. The camera is mounted on an articulated bracket 136 which is controlled by motors 138 to telescope and angularly rotate the bracket 136 to a working position where the camera 134 can view the tire inside wall. For inspecting the inner tire wall, the camera is moved forward a distance along the associated gripper axis and then is angularly rotated to reach a working position where the camera 134 can capture images of the tire inner wall. After inspection, the bracket 136 is moved through a reverse sequence to restore it to the standby position. To monitor outer tire wall condition, tire wall camera 140 is used, the camera being mounted on bracket 142. An exemplary flow diagram of operations undertaken in a tire inspection is shown in FIG. 48. FIG. 55 is a schematic flow diagram of a tire inspection control module.

### Tire Pressure Sub-System

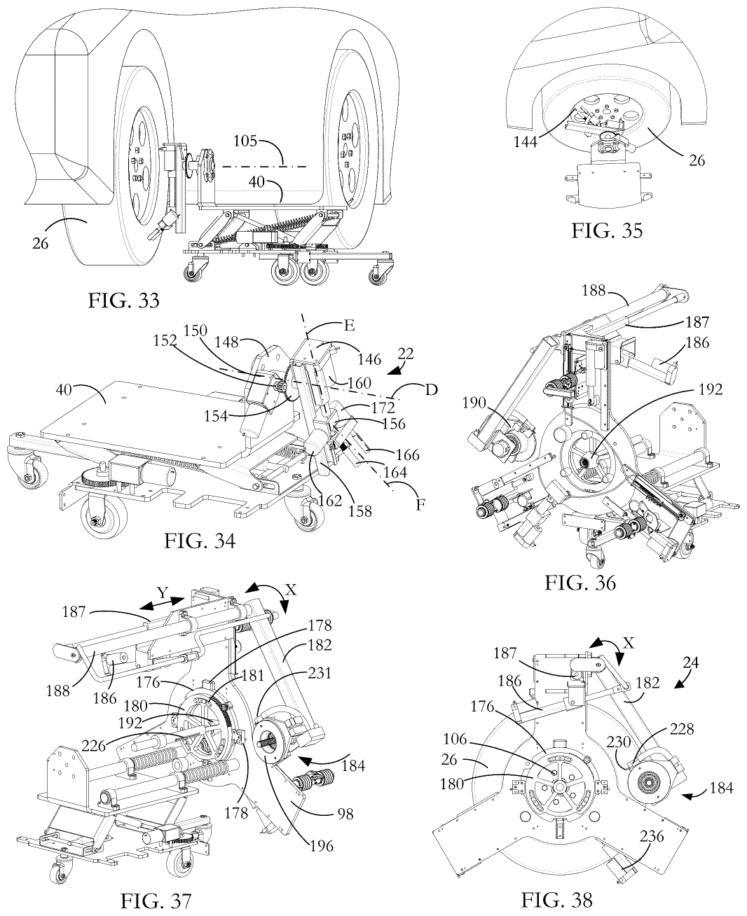

Referring to FIGS. 33 to 35, the robot tool has a sub-system 22 for testing tire pressure and for pumping or releasing air to correct tire pressure if the pressure is found to be under or over recommended pressure. For this service action, the target wheel 26 can be serviced without cither its removal from, or rotation relative to, the vehicle because, once the robot tool 8 is within a general communication range, the tire pressure sub-system 22 is manoeuvred under the control system working with a machine vision system to bring attachment elements of the sub-system 22 to a tire injection valve 144. Once in position, the tire pressure sub-system 22 operates to grab, twist and remove an injection valve cap, to measure tire pressure, to pump or release air to the recommended tire pressure, to reposition and screw down the valve cap and finally to restore the tire pressure sub-system 22 to its standby position. Tire pressure service actions can be implemented regardless of the wheel rotation position because of inherent mobility capability provided by drives to the chassis 10, to the support plate 40 and to the tire pressure sub-system itself.

Elements of the tire pressure sub-system 22 are mounted on a frame 146 as shown in FIG. 34 which illustrates the back of the robot tool. The frame 146 is mounted to upstanding wall 148 integral with the support plate 40. The frame 146 is rotatable about tool operational axis D upon operation of rotary motor 150 acting through a drive pinion 152 and a driven gear 154. A carriage member 156 is slidably mounted on a linear rail arrangement 158 forming part of the frame 146. The carriage member 156 can be reciprocally driven in a direction E by linear motor 160 to desired stop positions. A bracket member 157 is mounted for angular movement to a desired inclination F under a drive from rotary motor 162. An air pressure unit 164 and a cap remover unit 166 are closely mounted on bracket member 157, support bodies for the units extending parallel to each other in inclination direction F. The cap remover unit 166 has an attachment tube with opposed fingers which are splayed outwardly as the attachment tube is manoeuvred onto a tire injection valve cap so as to grasp the cap and enable it to be turned. The fingers are lined with a layer of resilient gripping material or another form of resilient spring grip can be used. Rotary motor 172 is operated to rotate the cap remover tube and unscrew or screw down the cap from/onto a tire injection valve 144. An Air pressure unit 164 is pneumatically connected through nozzle 174 to a pressure sensor, air ducts, valves, air pump and a pneumatic control unit (none shown) connected to the control system for use in measuring tire pressure and delivering/releasing air at desired pressures to/from the tire injection valve 144. Imaging devices mounted on the tool are used to identify the position and orientation of a particular valve 144 so that the air pressure sub-system can be moved by suitable movement of the chassis and support plate motors and the motors 160, 162, 172 into registration with valve 144. In operation, the frame 146 and the elements mounted on it are moved to a first position to detach the valve cap from the wheel injection valve with the valve cap remover 166 and then shunted over to a second position at which air pressure can measured and air can be pumped into or released via a connection between the air pressure unit 164 and the wheel injection valve.

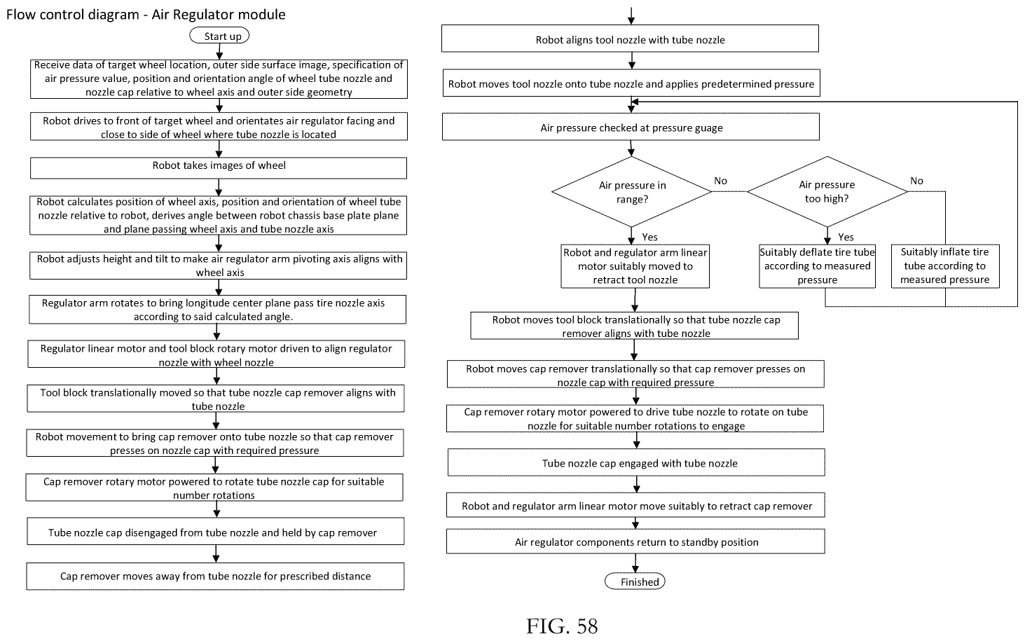

FIGS. 33 and 34 show the tool chassis 10 and support plate 40 but with tool components other than the pressure sub-system 22 not shown. FIG. 33 shows the pressure unit in a standby position beside a target wheel 26 to be serviced. Initially, axis D is unlikely to be aligned with the wheel axis and so drives to the chassis 10 and support plate 40 are operated until axial alignment is obtained. As shown by FIG. 34, drives to motors have been activated as needed to angularly adjust the position of the frame and the support bracket in readiness for placing the cap remover coaxial with and over the injection valve cap (FIG. 35). The cap remover is rotated by rotary motor to undo the cap which, following removal, remains held by the cap remover finger. The pressure unit is then moved backwards, shunted sideways to bring the pressure nozzle into alignment with the tire injection valve collar and then moved axially forward to press the nozzle over the valve collar until the engagement between the collar and the nozzle is sealed. A control sequence is then initiated to check air pressure and, as necessary, to pump air into, or release air from, the tire until the recommended tire pressure is reached. Then connection nozzle 174 is axially moved backward to leave the tire valve. The tool is again moved backwards and again shunted sideways to bring the cap remover into alignment with the injection valve collar. The valve cap remover is then moved axially forward to press the held cap onto the collar and rotary motor is operated to screw down the cap onto the collar until a required torque is obtained and the pressure unit can be removed leaving the cap in place. FIG. 58 is a schematic flow diagram of a pressure regulator control module.

Referring to FIGS. 36 to 42, robot wheel servicing tool 8 has a wheel balancer sub-system 24 for dynamically balancing a wheel 26 that has been detached using a fastener removal sub-system and a gripper sub-system such as those previously described. As shown in FIG. 38, the wheel balancer includes a first back plate 176 mounted to tri-form plate 98 by vibration sensor 178. A second back plate 180 mounted coaxially against plate 176 has a plurality of arc wedge slots, and respective arc wedge blocks engaging with threaded rotary rod arrangement 181 allowing limited circumferential adjustment of plate 180 relative to plate 176, and also allowing plate 180 fixed to plate 176 by rotating the rotary rod to drive the wedge block to press on arc wedge slot. Plate 176 has a central circular opening and spoked plate 180 has sector-shaped access openings which, subject as necessary to such adjustment, permit full access by a fastener loader unit 14 for removing and attaching fasteners on wheel 26 when the fastener loader unit 14 needs to rotate a suitable angle to match the orientation of the lug nuts pattern on the wheel.

Alternatively, the tool base is mounted on a robot arm as the EOAT (End Of Arm Tool), the robot arm wrist can move the robot tool to a desired position in desired orientation in 3D space. In this case, the fastener loader doesn't need to rotate along the tool operational axis relative to the tool base, to get it aligned with the orientation of the wheel lug nuts layout.

Alternatively, when the gripper holds the wheel in order to detach it from the vehicle, or install it onto the vehicle, the car is operated to let the wheel bearing hub to be free of being rotated a specific angle driven by rollers on the gripper or the vehicle itself, so that each threaded stud aligns with respective socket on the fastener load unit 14.

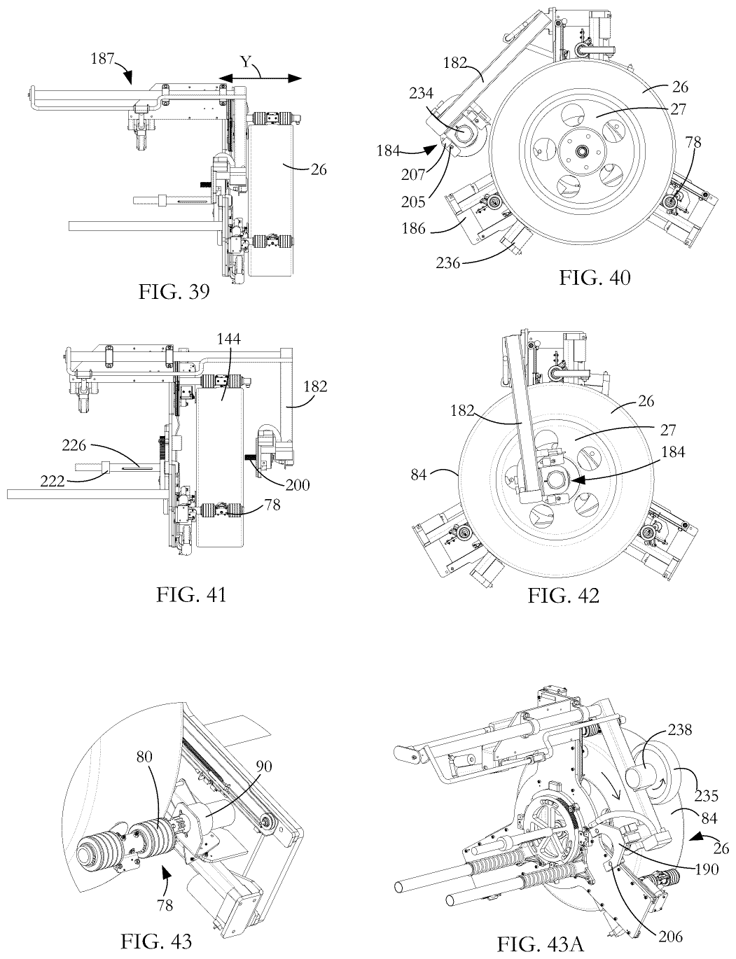

As shown in FIGS. 38 and 39, wheel balancer 24 has an operating arm 182 on which is mounted a pressure plate assembly 184 and several subsidiary mechanisms used during wheel balance testing and correction. Operating arm 182 is driven by motor 186 to angularly rotate in direction X and a linear actuator 187 (FIG. 36) for reciprocally moving shaft 188 and operating arm 182 in direction Y.

One purpose of operating arm 182 is to transfer pressure plate assembly 184 between an ‘off axis’ standby position shown in FIGS. 38, 39 and 40 and an ‘on axis’ operational position shown in FIG. 42 in preparation for a wheel balancing operation. During transfer, as shown in FIG. 41, articulated operating arm 182 moves pressure plate assembly 184 from a position on the tool side of gripped wheel 26, around outside of wheel 26 to clear it, and then into the position aligned with the tool operational axis on the side of gripped wheel 26 facing away from the main part of the wheel balancer.

Another purpose of operating arm 182 is to remove a wheel center cap 203 from the wheel 26. The center cap (FIGS. 46, 47) is a cover mounted at the center of a wheel by clips. In normal road use, cap 203 protects vehicle wheel axle spindle nut and bearing (not shown) from dust and or foreign bodies. Cap 203 must be removed from wheel 26 so that wheel 26 can be mounted with its center bore in a manner enabling a dynamic balance check to be made. To remove cap 203, operating arm 182 is manipulated so that an end of threaded shaft 200 forming part of pressure plate assembly 184 approaches wheel 26 (FIG. 41) and pushes cap 203 against the holding force of clips (not shown) to eject it from wheel 26 (FIG. 47). Mounted between the wheel and the tri-form member is a center cap catching mechanism 236 (FIGS. 46 and 47). Before cap ejection, an operating arm of cap catching mechanism 236 is driven by a linear actuator to a point where a catcher head 237 is aligned with the wheel center. When cap 203 is ejected from wheel 26, it engages and is held by the catcher head 237, then the catcher head retracts to a standby position off center from wheel center axis until wheel balancing is completed. Currently, commercially available wheel center caps vary in form, size, and composition so it is necessary that the cap catcher be adaptable for catching different sizes and forms of cap. It is anticipated however that as robotic servicing of vehicle wheels becomes more widespread, center cap primary dimensions will become standardized. In one alternative form, such caps have a ferromagnetic core and a catcher arm head houses an electromagnet operable to magnetically attract and hold the cap as it is ejected from the wheel. In another alternative, the cap is driven into an array of upstanding pins which flex outwardly and, together, resiliently hold the cap when the cap catching mechanism is withdrawn.

Once cap 203 is removed, and with pressure plate assembly 184 still centered on the tool operational axis (FIG. 41), operating arm 182 is further manipulated to move pressure plate assembly 184 along the tool operational axis towards rim 27 (FIG. 40) and towards a pressure member such as cone block assembly 192 (FIG. 36) mounted to the tool base. A wheel to be balanced has a flat on-inner side of the rim which, when the wheel is mounted on a vehicle, bears against a corresponding flat face of the whee bearing hub.

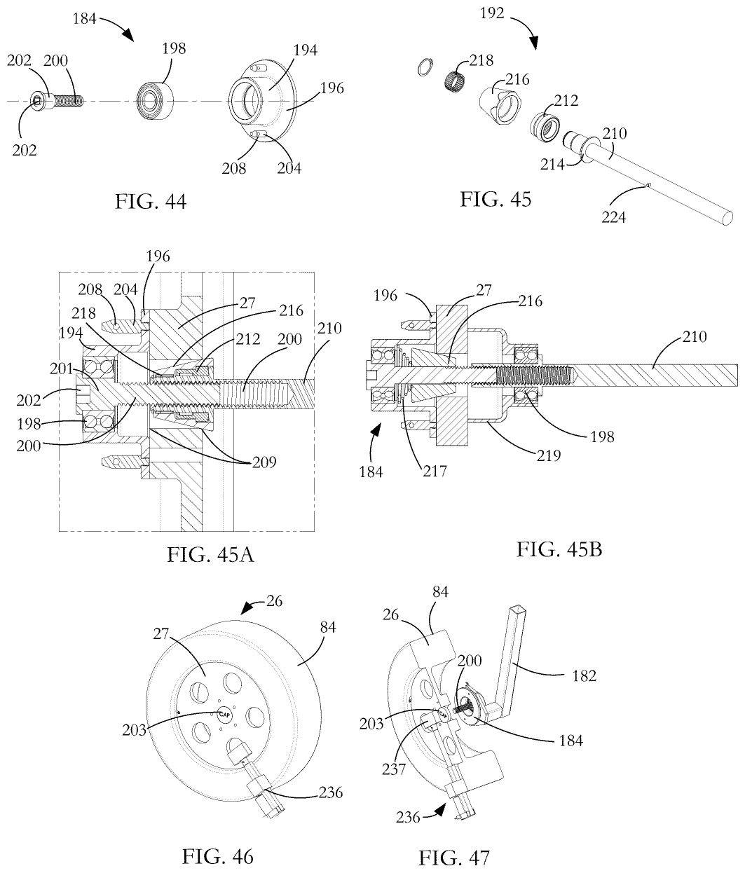

As shown in FIGS. 43A, 44 and 45A, a holder 190 is mounted on operating arm 182. Pressure plate assembly 184 has a drum 194 and integral flanged pressure plate 196. Fixed in the interior of the drum is a bearing 198, the inner race of bearing 198 being fixed to oversized head end 201 of threaded shaft 200. Head end 201 has a shaped driver recess 202 to receive the end of a rotary impact driver 234 fixed to the holder 190. Pins 204 integral with pressure plate 196 are received in corresponding bores 206 on holder 190 (FIG. 43A) when the pressure plate assembly 184 is in standby and approaching positions. Holes 208 in pins 204 (FIG. 44) accommodate plungers 205 of solenoid 207 (FIG. 40) movable into and out of holes 208 to lock and unlock pressure plate assembly 184 relative to holder 190, solenoid 207 is fixed on the holder 190.

As shown in FIGS. 45 and 45A, cone block assembly 192 has a shaft 210 with a radial thrust bearing 212 fixed to one end of the shaft 210 and bearing against flange 214 of the shaft. One end of the center bore cone block 216 is freely rotatably mounted on a needle roller bearing 218 fixed to the same side end of shaft 210, another end of cone block 216 is mounted on the outer race of radial thrust bearing 212. At the end of the shaft 210 where the cone block 216 is equipped, the shaft 210 has an internally threaded bore which is screw-engageable with threaded shaft 200 of the pressure plate assembly 184.

In setting up for a wheel balance test, three grippers 78 are moved linearly along their axes to bring a wheel touches the edges of fins 94 (FIGS. 1, 23A), then all grippers move radially inward to hold the wheel tread face, all wheel lug nuts are detached and then the wheel is separated from wheel bearing and taken out of the wheel well. Arm 182 is then articulated to bring pressure plate assembly 184 onto the tool operational axis. Before the threaded shaft 200 of the pressure plate assembly enters the rim center bore, it is rotated in a low torque mode by impact driver 234 lodged in recess 202. Further articulation of arm 182 presses the pressure plate 196 against the interior flat side of rim 27.

On the reverse side of wheel 26, shaft 210 and cone block assembly 192 are driven towards the gripped wheel 26 by linear actuator 222 with shaft 210 constrained to move parallel to the tool operational axis by engagement of pin 224 in slot 226. The internal threaded bore of shaft 210 will firstly meet shaft 210, then cone block assembly 192 continues to move toward rim. In another alternative sequence of operation, the cone block assembly can also be moved earlier than the pressure plate assembly to make the cone block contacts the rim center bore edge firstly, then pressure plate is manipulated to the rim center bore and flat, along with motor 234 running in low torque mode. Until contact between rim center bore edge 209 (FIG. 45A) and cone block 216 is detected by the on-board machine vision system or by monitoring an increase in current to rotary impact driver 234 caused by resistance to further movement of shaft 210, the impact driver is then operated in high torque mode to drive shaft 200 further into bore 220 and thereby securely to clamp rim 27 between pressure plate 196 and cone block 216. The grippers then leave the wheel tread face, shaft 210 is then driven forward a short distance to ensure the wheel is spaced from the edges of fins 94.

In standby and approach positions, pressure plate assembly 184 is held by pins 204 integral with pressure plate 196 received in corresponding bores 206 in holder 190 (FIG. 36). Holes 208 in pins 204 (FIG. 44) accommodate solenoid plungers movable into and out of holes 208 to attach and release pressure plate assembly 184 relative to holder 190. After pressure plate 196, rim 27, and cone block 216 are clamped together, solenoids 207 are powered on to retrack solenoid plungers 205 out of holes 208, and articulated arm 182 is driven to slide holder 190 off drum pins 204. Articulated arm 182, minus pressure plate assembly 184, is then returned to its standby position and grippers 78 are lifted from wheel tread surface 84. This leaves wheel 26 freely rotatable about its central axis in a balance test position. Pressure plate assembly removal from a wheel following completion of the wheel balance test uses a reverse sequence of steps.

As shown in FIG. 43, a roller 80 on one of grippers 78 is connected to rotary actuator motor 90 which is driven to rotate roller 80 when needed. Powered roller 80 is firstly brought to bear against wheel tread surface 84 so that powered roller rotation results in counter-rotation of wheel 26, together with the pressure plate assembly 184. Wheel 26 is rotated slowly to enable tire inspection, cleaning, old weight removal, and new weight application, or is rotated at high speed for assessing and correcting wheel imbalance.

Referring to FIG. 43A, as an alternative to the driver roller being on one of the grippers, a larger roller 235 having no wheel gripping role is mounted on articulated arm 182. Articulated arm 182 is deployed when needed to bring roller 235 from a standby position to bear against wheel tread surface 84. Roller 235 is then driven to rotate by rotary actuator 238 to cause counter rotation of wheel 26. Larger diameter roller 235 can be spun more slowly than powered roller 80 to get the same wheel rotation rate.

In another embodiment, the cone block 216 is driven to rotate by a motor, to drive the wheel 26 to spin.

In a further embodiment, the pressure plate assembly is driven to rotate by a motor, to drive the wheel 26 to spin.

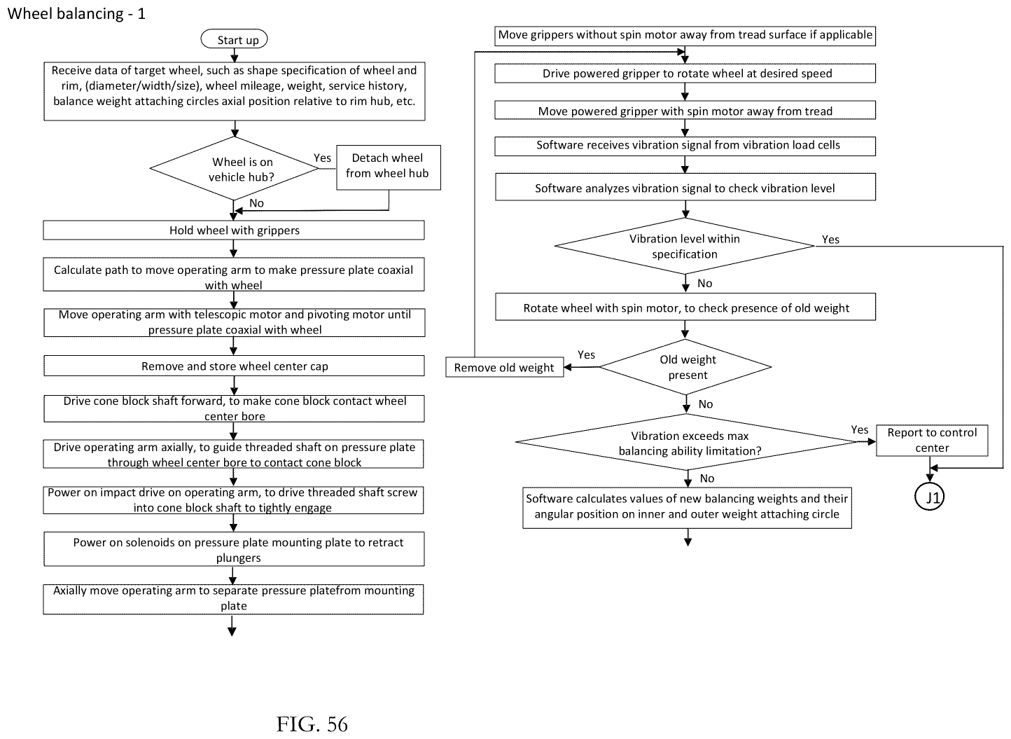

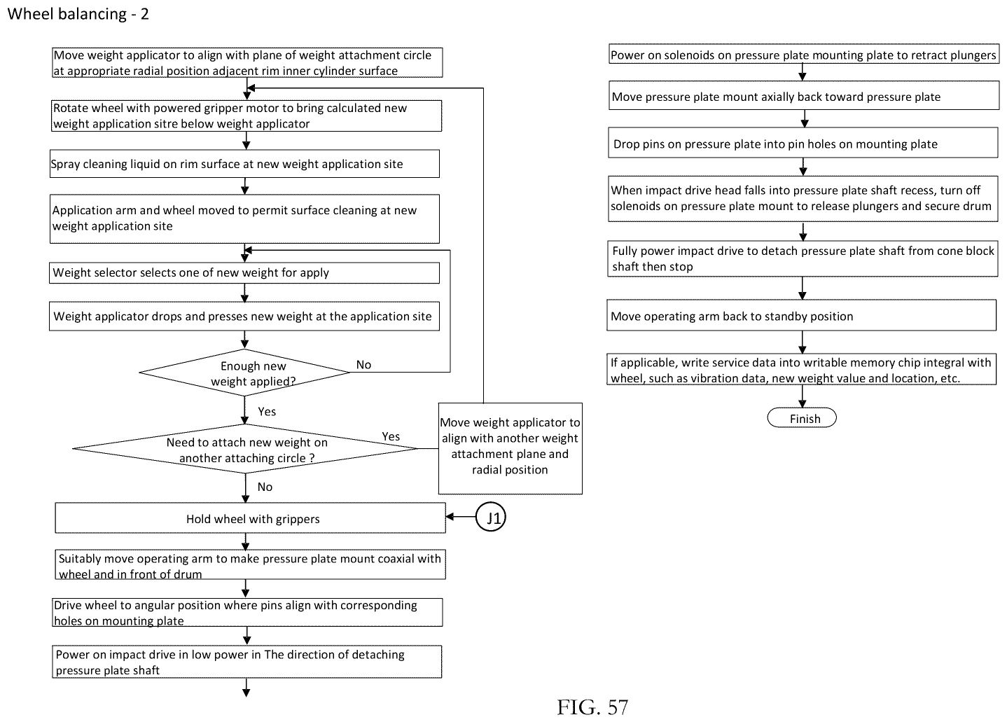

For a dynamic balance test, the powered roller on gripper 78 is rotated at a high rate to produce a corresponding fast rotation of wheel 26. Once wheel 26 is rotating at a desired speed, the powered roller can keep driving the wheel to maintain the wheel rotating speed, or, the powered roller is lifted from tread surface 84 so that wheel 26 spins freely. Shaft 210 has a rotary encoder (not shown) for indicating the rotary angle of cone block and, therefore, of wheel 26, so that rotary positions of wheel 26 can be related to the occurrence of wheel vibration artefacts by the control system. Any of several commercially available vibration analysis sub-systems may be integrated with robot tool control system and used to gather out-of-balance information. Transducers 178 (FIG. 37) for such vibration analysis sub-systems can be used with monitoring systems to measure at least two of x, y and z forces and to compute the extent and direction of imbalance. Wheel imbalance is resolvable into forces and moments acting at inner and outer planes near the ends of rim 27 and perpendicular to wheel axis. Imbalance information is used with stored or imaged rim size information to determine precise weight and rim mount positions of balance weights needed to balance wheel 26. FIGS. 56 and 57 are schematic flow diagrams showing a wheel balancing control module.

In the embodiment described, wheel 26 is shown with the rim flat side-the inside of the wheel when it is mounted on a vehicle—facing away from the main part of the robot tool. This is convenient because, when a wheel is demounted from a vehicle, there is no requirement to turn it around for set-up. It is simply transferred across from the vehicle from which it is demounted, at the same time guiding its axis onto the robot tool operational axis. In an alternative embodiment (not shown), the wheel is turned around, the pressure plate assembly is rotatably mounted to the shaft 210 on the tool base, so that the flat on the wheel interior faces a corresponding flat on the pressure plate. And a pressure member like a cone block mounted to the tool base has a mounting arrangement enabling it to be moved onto and along the tool operational axis on the other side of the rim.

Further mounted on operating arm 182 (FIG. 38) is a gravel remover 228 which is used with tire inspection sub-system 20 to identify the presence and location of gravel and like bodies in tire tread surface 84 as wheel 26 is being spun at low speed. Once identified, gravel is removed so that its weight will not affect a subsequent wheel balancing procedure. The gravel remover includes a picker or post 230 having a tip which, by coordinately driving the motors controlling the operating arm 182, is guided and directed into both primary back-to-front grooves and subsidiary cross grooves such as diagonally extending grooves. Adjacent the picker tip is a nozzle 231 (FIG. 37) pneumatically connected to a vacuum suction pump (not shown) which is used to suck dislodged gravel through the nozzle and into a storage bin (not shown). Another function of the operating arm 182 is to manipulate a camera (not shown) mounted on the arm into a position behind a wheel gripped by the gripper sub-system to inspect the inner side of the wheel rubber tube and rim.

As shown in FIG. 43B, mounted on a frame member 250 attached to operating arm 182 is an assembly consisting of an old balance weight remover 252, a rim cleaner 254, and a new balance weight applicator 256. The weight remover 252, rim cleaner 254 and weight applicator 256 are shown to a larger scale in FIG. 43C. Operating arm 182 is telescopically extensible from a base mounting on the tool frame to enable a particular tool head to be moved to axial positions at inner and outer ends of the rim. The arm is also angularly rotatable about the base to enable a tool head to be moved to a desired radial position depending on the radius of the rim.

Referring to FIG. 43D, the old balance weight remover 252 is used to remove a balance weight (not shown) that has, on a prior service occasion, been applied to the wheel rim following a previous balance test if an imbalance was detected. In order to remove the old weight, the robot tool controller which may be autonomous, remote or a combination of the two, compares a camera-derived image of the rim and a stored image of a corresponding rim without balance weights to identify location and type of the old balance weight, or compares the images of the rim at different position to find out the position of the old weight. The end of the operating arm 182 and integral frame member 250 are then guided to an appropriate position beside the wheel rim surface. The old weight remover 252 has a scissors structure with the scissor operation driven by linear actuator 258 and with the end of each limb 260 of the scissors formed with a chisel edge 262. To remove the old weight, the wheel is rotated along with linear and rotary movement of the operating arm 182 to bring the old weight to a position in which 2 not adjacent ends of the weight locate under and between the chisel edges 262. The operating arm 182 further rotates toward the rim wall surface until the chisel edges 262 are close enough to the rim wall surface The scissors are then closed to insert the chisel edges into the bottom of the old weight at its 2 not adjacent ends, then the scissors are closed further to prize the weight from the rim. The old weight then is collected to a collection bin (not shown). A machine vision control system using cameras, sensors, etc., is used to guide the old balance weight remover 252 and to turn the wheel to bring the old balance weight remover to the required relative positions and to implement the scissoring cycle. The control system can include an inspection subsystem to monitor the relative positioning and the weight removal cycle.

Referring to FIGS. 43E, the rim cleaner 254 is used to remove dust, grease, and suchlike from a site on a rim at which a new weight is to be applied. The rim cleaner has a base 264 which, in use, is attached to frame member 250. Mounted on the base 264 is a reel-to-reel cassette having a feed reel 266, a take-up reel 268 and a rotary motor 270. The take-up reel is driven by motor 270 during cleaning to drive a cleaning strip 272 extending between the reels from reel 266 to reel 268. An active part of the strip is pressed by a spring mounted deflector 274 against the rim. Co-mounted on the head is a nozzle 276 to which cleaning fluid is pumped and from which a charge of the fluid is directed at the rim prior to operation of the cleaning strip. Because the angular position of the wheel is known from a real-time output from the rotary encoder during the balance test, the weight application head and the desired weight application location(s) on the rim can be accurately brought together. By coordinated wheel rotation and manipulation of operating arm 182, rim cleaner 254 is brought to a computed weight fixture site where cleaning liquid is sprayed from nozzle 276 at the weight fixture position. The site is then cleaned by the cleaning strip 272. When clean strip at the feed reel 266 is used up, the cassette is replaced. A machine vision control system using cameras, sensors, etc., is used to guide the rim cleaner 254 and to turn the wheel to bring the cleaning head and the rim together and to implement a cleaning cycle for a predetermined amount of time. The control system can include an inspection subsystem to monitor the cleaning cycle and to ensure that the rim is sufficiently cleaned to enable effective application of a balance weight to the rim.

Referring to FIG. 43F, the balance weight applicator 256 is used to apply a new balance weight 290 to the wheel rim after a wheel imbalance is detected and a new weight application site is identified and cleaned. To apply the new weight, the robot tool controller which may be autonomous, remote or a combination of the two, compares a camera-derived image of the rim and the data acquired during the wheel balance test to determine the location on the rim where the new weight is to be applied and to identify the weight and quantity of required new weight to be added. The end of the operating arm 182 and integral frame member 250 are then guided to an appropriate position beside the wheel rim surface. Mounted on a new weight applicator base 278 is a second reel-to-reel cassette having a feed reel 280, a take-up reel 282, and a rotary motor 284. The take-up reel 282 is driven by motor 284 to drive a strip 286 of new weights 290 extending from reel 280 to reel 282. An active part of the strip is punched by a spring mounted deflector 288 against the rim. Each of the new weights 290 in the cassette adheres to strip base ribbon 292 by means of a low adherence glue and is coated on its outer surface by a high adherence glue. Consequently, after a weight 290 is punched against the wheel rim by deflector 288 and the deflector withdraws, the punched weight 290 remains adhering to the rim. A machine vision control system using cameras, sensors, etc., is used in guiding the new balance weight applicator and the wheel rim to the required relative positions and to implement the weight application cycle. The control system can include an inspection subsystem to monitor the relative positioning and the weight application cycle. Balance weights are normally fixed to the inner cylindrical surface of the rim at the position close to the end of the rim to achieve balance. A weight cassette can contain different weights or can contain standard weights. In the latter case, several weights may be applied to make up the computed weight.

In the aforementioned wheel balancer sub-system, the wheel rim is sandwiched and clamped by the cone block and pressure plate. As shown in 45B, in another embodiment of the wheel balancer sub-system, the cone block 216 is coaxially placed inside of the drum integrated with the pressure plate with the cone block conical surface facing outwardly, a conical compression spring 217 between the drum inner wall and the cone block biases the cone block outwardly. The wheel can be clamped by the pressure plate and cone block combination at the rim flat, and another drum 219 in a second pressure assembly from the other side of the wheel rim. The biased cone block can retract and press on the corresponding rim center bore edge to center the wheel center bore therefore align the wheel axis with the tool operational axis. The said second pressure assembly has the similar structure as the cone block assembly 192, the difference is the cone block is replaced by a drum 219.

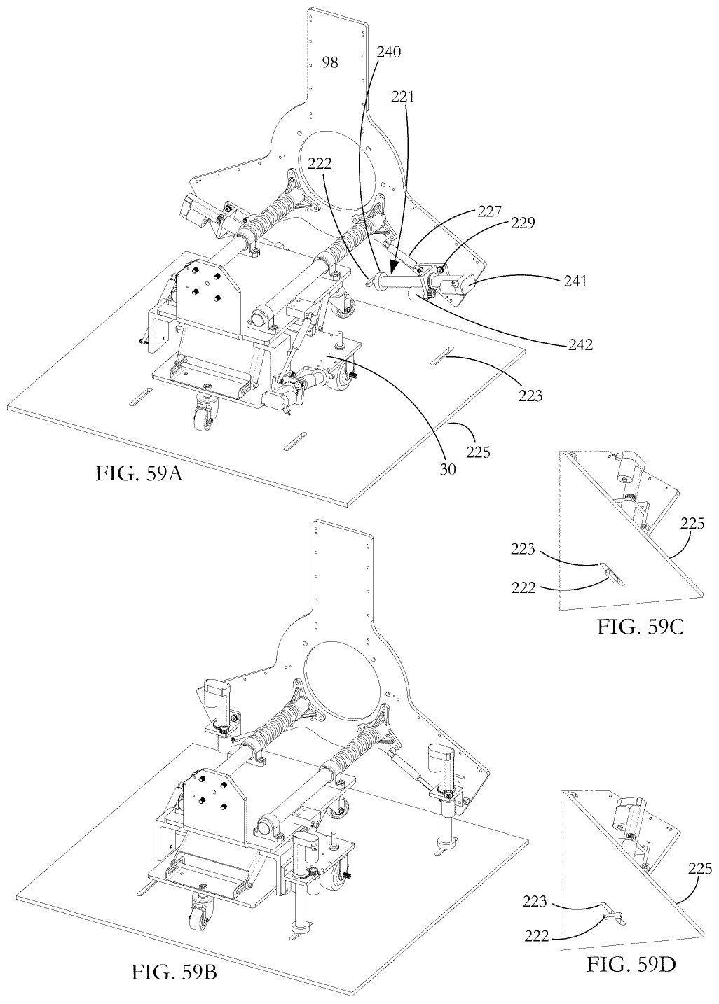

In a further embodiment, as shown in FIG. 59A, 59B, in order to anchor the robot tool to reduce robot tool vibration for higher test accuracy and safety when the wheel spins in a high speed in balancing test, 4 anchoring units 221 are pivotably installed on the tri-form plate 98 and tool base plate 30 to anchor the robot tool to a stationed object such as the floor 225 or ground. An actuator 227 can extend to deploy the anchoring unit to vertical orientation for anchoring, or retract and nest the anchoring unit to a tilted standby orientation. On the surface where the robot tool stands on such as the floor, there are corresponding slots 223 placed in the same layout as the anchoring unit on the robot tool. Before the wheel is spined in high speed for balancing test, the robot tool moves to the position above the slots, then lift the tool base plate and keep it horizontal, then deploy the anchoring unit to vertical orientation, then robot tool tunes up its position and orientation to aim the bottom of each anchoring unit with the corresponding slot, then robot tool lower the base plate vertically to insert the T bar 222 on the feet of all anchoring unit into the corresponding slots 223 on the floor, as shown in FIG. 59C, until the stop 240 on the anchoring unit contacts the floor. T bar 222 is fixed to the end of a linear actuator 241. Then a drive 242 rotates the linear actuator 241 to make the T bar to be perpendicular with the slot, as shown in FIG. 59D. Then linear actuator 241 retracks until the T bar pressed the lower face of the floor with sufficient high pressure, then the stop 240 and the T bar 222 sandwich and clamp the floor, therefore the tri-form plate and base plate are clamped to the floor. When robot tool is not anchored to the floor, T bar 222 is parallel to the respective slot 223, and when T bar 222 and stop 240 clamping the floor, T bar 222 is angled to the slot 223 such as perpendicular. There can be other type of clamping for anchoring the robot tool, such as clamping to the studs, holes or other features on the floor, or clamping by electromagnet, as long as the triform plate 98 and/or base plate 30 can be fixed to the floor or ground. While the previous description is of a robot wheel servicing tool that combines a chassis sub-system 10, a tool support sub-system 12, a fastener detaching/attaching sub-system 14, a fastener storage sub-system 15, a jacking sub-system 16, a gripper sub-system 18, a tire inspection sub-system 20, a tire pressure sub-system 22, and a wheel balancing sub-system 24, in other embodiments of the invention a subset of these sub-systems forms the hardware part of the robot tool with the control system having a corresponding subset of control software. For example, in some applications, a tire pressure sub-system does not form part of the robot tool; in other applications, a wheel balancing sub-system does not form part of the tool.

Other variations and modifications will be apparent to those skilled in the art and the embodiments of the invention described and illustrated are not intended to be limiting. The principles of the invention contemplate many alternatives having advantages and properties evident in the exemplary embodiments.

What is claimed is:

1. A mobile robot tool for use in testing balance of a wheel, the wheel having a rim, a center bore through the rim, and a rim flat surrounding the bore at one end thereof, the tool comprising
a tool base,
a first assembly comprising a first pressure member mounted for rotation about a part of a first attachment element, and a first drive operable to drive the first pressure member along a tool operational axis in a first direction to cause the first pressure member to contact and bear against the rim on one side thereof, the wheel axis is coaxial with said tool operational axis when said wheel is being spined for balance testing.
a second assembly comprising a second pressure member mounted for rotation about a second attachment element, and a second drive operable to drive the second pressure member in a second direction opposite to the first direction to cause second pressure member to contact and bear against the rim on the other side thereof.

2. The mobile tool claimed in claim 1, further comprising a third drive to drive a fastening clamping engagement between the attachment elements to clamp the wheel rim between the attachment elements pressure members in a wheel test position.

3. The mobile tool claimed in claim 1, wherein at least one of the first assembly and the second assembly is mounted to the tool base by an articulated mounting permitting the respective assembly to be driven between a first position in which the rotary axis thereof is not aligned with the tool operational axis, and a second position in which the screw axis thereof is aligned with the tool operational axis.

4. The mobile tool claimed in claim 2, wherein the articulated mounting extends between the first assembly and the tool base, and the first drive is further operable to drive the mounting to move the first assembly between a first position on one side of the wheel and a second position on the other side of the wheel when the wheel is in a wheel pre-test position.

5. The mobile robot tool claimed in claim 4, wherein the first drive, in moving the first assembly between the first position and the second position, moves the first assembly around the wheel.

6. The mobile robot tool claimed in claim 1, wherein the first attachment element is a threaded shaft coaxial with the cylindrical head of a pressure plate member which bearingly rotates, and the second attachment element is an end part of a shaft mounted to the tool base and axially aligned with the tool operational axis, the shaft end part having a threaded bore extending axially thereinto.

7. The mobile robot tool claimed in claim 1, wherein the first assembly further comprises a driver to provide the first drive, the driver engageable with the first attachment element to screw drive the first attachment element.

8. The mobile robot tool claimed in claim 1, wherein the first assembly further comprises a holding member connected to the pressure plate member, wherein the holding member is disconnectable from the pressure plate member when the wheel is in the test position, thereby leaving the wheel and the first assembly free to rotate about a central axis thereof.

9. The robot tool claimed in claim 1, further comprising a roller mounted to the tool base, a fourth drive to drive the roller from a standby position to a position in which an outer surface of the roller bears against an outer treaded surface of the wheel when in the test position, and a fifth drive to rotate the roller about a central axis thereof, whereby to counter-rotate the wheel.

10. The mobile robot tool claimed in claim 8, further comprising a vibration monitoring sub-system mounted on the tool base for monitoring at least two of x, y and z vibrations of the wheel when the wheel is counter-rotating in the test position, and for relating the vibrations to respective positions on the wheel.

11. The mobile robot tool claimed in claim 1, further comprising at least three grippers mounted to the tool base, wherein the wheel grippers are deployable to grip an outer tread surface of wheel and to maneuver the wheel from a vehicle mount position to the pre-test position.

12. The mobile robot tool claimed in claim 11, wherein at least one of the grippers incorporates a roller moveable to a position bearing against an outer treaded surface of the wheel in the test position, and a drive to rotate the roller, thereby to counter-rotate the wheel.

13. The mobile robot tool claimed in claim 1, wherein the tool base is mounted on a chassis having a roller set for supporting the chassis on a supporting surface, the mobile robot tool further comprising a drive to the roller set operable to effect any of rectilinear, curvilinear and spin motion of the chassis on the supporting surface.

14. The mobile robot tool claimed in claim 1, wherein the tool base is mounted on a chassis for movement on a supporting surface, the mobile robot further comprising a drive to effect tilt of the tool base relative to the chassis from a level position to a tilted position.

15. The mobile robot tool claimed in claim 1, wherein the tool base is mounted on a chassis for movement on a supporting surface, the mobile robot further comprising a drive to effect a change of height of the tool base relative to the supporting surface.

16. The mobile robot tool claimed in claim 1, further comprising a tire inspection sub-system mounted on the tool base, the tire inspection sub-system operable to inspect the wheel.

17. The mobile robot tool claimed in claim 16, further comprising a foreign body removal sub-system operable to remove foreign bodies detected by said tire inspection sub-system to be lodged in a tread surface of the wheel.

18. The mobile robot tool claimed in claim 1, further comprising an old weight removal sub-system mounted to the tool base, the old weight removal sub-system deployable to remove old weights from the wheel rim when the wheel is in the test position and prior to performance of a balance test of the wheel.

19. The mobile robot tool claimed in claim 1, further comprising a new weight application sub-system mounted to the tool base, the new weight application sub-system deployable to apply new weights to the wheel rim when the wheel is in the test position and following performance of a balance test of the wheel.

20. A method for use in testing balance of a wheel, the wheel having a rim, a center bore through the rim, and a rim flat surrounding the bore at one end thereof, the method comprising
driving a first assembly comprising a pressure plate member forming part of a mobile robotic tool and mounted for rotation about a part of a first attachment element along a tool operational axis in a first direction to cause a pressure plate member to bear against the rim flat at one end of the rim center bore,
driving a second assembly forming part of the mobile robotic tool and mounted for rotation about a second attachment element in a second direction opposite to the first direction to cause a conical surface thereof to bear against an edge of the rim center bore at the other end of the rim center bore, wherein the second attachment element has a second screw portion having a second screw axis, and
screw engaging a first screw portion forming part of the first attachment element and having a first screw axis with a second screw portion forming part of the second attachment element and having a second screw axis, and driving the engagement between the first and second screw portions to clamp the wheel rim between the attachment elements in a wheel balance test position.
Clamp the tool base to ground.
